(19) United States
(12) Patent Application Publication
(10) Pub. No.: US 2026/0072891 A1
(43) Pub. Date: Mar. 12, 2026

(54) ELASTIC VECTOR INDEX MEMORY POOL SIZE FOR A VECTOR DATABASE

(71) Applicant: Oracle International Corporation, Redwood Shores, CA (US)

(72) Inventors: Teck Hua Lee, San Mateo, CA (US); Agnivo Saha, Belmont, CA (US); Aurosish Mishra, Sunnyvale, CA (US); Luis Elizalde, Zapopan (MX); Benita Kathleen Britto, Sunnyvale, CA (US); Vinita Subramanian, Campbell, CA (US); Gary Smith, Auburn, CA (US); Lan Bai, Belmont, CA (US); Shasank Kisan Chavan, Menlo Park, CA (US)

(21) Appl. No.: 19/040,924

(22) Filed: Jan. 30, 2025

Related U.S. Application Data
(60) Provisional application No. 63/692,487, filed on Sep. 9, 2024.

(51) Int. Cl. G06F 16/22; G06F 12/02; G06F 16/901

(52) U.S. Cl. CPC G06F 16/2237; G06F 12/0238; G06F 16/9024

(57) ABSTRACT

A size of a neighbor graph vector index can be estimated. The neighbor graph vector index can be an index of neighbor vertices for a graph-based approximate nearest neighbor search in a vector database. A vector memory pool size of a vector memory pool in a database instance memory can be determined based on the estimated size of the neighbor graph vector index. The database instance memory contains data and control information for a database instance. The neighbor graph vector index can be stored in the vector memory pool. An operation affecting available space in the database instance memory can be detected. The vector memory pool size can be automatically adjusted in response to detecting the operation.

### CROSS-REFERENCE TO RELATED APPLICATIONS

This application is related to U.S. patent application Ser. No. 18/885,640, filed on Sep. 14, 2024, the entire contents of which is hereby incorporated by reference.

### BENEFIT CLAIM

This application claims the benefit of provisional application 63/692,487, filed Sep. 9, 2024, the entire contents of which is hereby incorporated by reference.

### FIELD

The present disclosure relates generally to vector indexes and, more particularly, to elastic vector index memory pool size for a vector database.

### BACKGROUND

A vector is a fixed length sequence of numbers, typically floating-point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) algorithms. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

Today, vectors are often generated by machine-learned models (e.g., neural networks) and the features they represent are often difficult for humans to understand. One way that vectors are produced by neural networks is by capturing the outputs of the neurons in the penultimate layer, i.e., the neural network's outputs just before the final processing layer.

### Distance Between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance between the vector for the word “cat” and a vector for the word “plant.”

The distance between two vectors is often calculated by summing the squares of the difference between the numbers in each position of the vectors:

(Vector1[1]−Vector2[1])\hat{ }2+(Vector1[2]−Vector2[2])\hat{ }2+ . . .

The property that vector distance represents object similarity is what allows similar data to be found using a vector database. For example, when a vector representing a picture of a dog is searched for in a vector database, the nearest vectors will be those representing other dogs, not vectors representing plants.

### Vector Processing Workloads

Vector processing workloads (not to be confused with single instruction, multiple data (SIMD) vector processing) have been used in Natural Language Processing (NLP), image recognition, recommendations, etc. Vector processing workloads have two sub-categories that require separate optimization strategies: indexing and searching. Regarding indexing, vector embeddings (or simply vectors) are indexed using approximate indexing techniques. Unlike B-tree indexes, a vector index returns many matching values ranked by similarity. Index creation and rebuild tend to be CPU intensive and are optimized for throughput.

Regarding searching, the stored vectors are searched using a class of algorithms known as “Similarity Search” or “Approximate Nearest Neighbor (ANN)” to find the closest vectors to a query vector. A search is designed to minimize CPU usage in order to minimize response time.

### Vector Processing Patterns

A vector similarity search is like interactive online transaction processing (OLTP) in that end-users submit vector queries and expect an instant reply. Vector similarity search requires millisecond response times to find vectors that are close (represent similar data) even when the database in which the vectors are stored holds billions of vectors. An example query is “find products that are similar to this picture” [reference to a digital image].” Another example query is “find corporate documents that conceptually match this natural language prompt: [NL prompt].”

Providing fast response times requires using specialized vector indexes and fast algorithms for computing distances between vectors. In some use cases, there is a need to combine vector similarity search with relational data. For example, a query may ask for data about houses that match a natural language prompt, are valued at over $1M, are in zip code 94070, and whose owner recently declared bankruptcy. Also, there may be a need to be able to insert new vectors into a database, delete vectors from the database, and index the vectors in real time.

### Vector Databases

Early vector workloads often used flat files or object stores to store vectors. An application would read the vectors out of their backend repositories into memory and perform vector processing using third-party libraries, such as Facebook® artificial intelligence (AI) similarity search (FAISS). Generative AI has greatly increased the volume and processing needs for vectors. Generative AI requires support for much higher volume ingest and faster filtering and retrieval. A database with vector capabilities and built-in indexing is important for these applications.

### Vector Memory Pool

A vector index, such as an in-memory neighbor graph vector index (aka Hierarchical Navigable Small Worlds (HNSW) index or HNSW graph) or an Inverted File Flat vector or Inverted File vector (IVF) index, is created in a special System Global Area (SGA) region called the vector memory pool. The SGA is a memory area that contains data and control information for one database instance. All server and background processes can share the SGA. If multiple users are concurrently connected to the same instance, then the data in the instance's SGA is shared among the users. Consequently, the SGA is sometimes considered a shared global area.

The vector memory pool enables vector index creation. The vector memory pool is a memory allocated in SGA to store HNSW vector indexes and associated metadata. It is also used to speed up IVF index creation as well as data manipulation language (DML) operations on base tables with IVF indexes.

### Vector Index Size

Most components that use a shared memory in the database have a very convenient small granularity. One example is the buffer, cache, or buffer pool and page small blocks are paged in and out of the buffer cache. Such a traditional database memory consumer does not need the entire data set to fit in the memory. Other components that use a shared memory in a database include the structured query language (SQL) and cursors, which are also relatively small, such as a couple of Kilobytes. Even in-memory columnar units are relatively small compared to vector indexes in terms of vector memory pool footprint for each unit of data that is paged into and out of memory.

However, a vector index is a whole new ball game, because it can have a size of multiple gigabytes and more. This causes a problem because the whole vector index either fits in the memory or it cannot be stored or must be purged when space is unavailable.

For example, an HNSW index can use a very large amount of memory (multiple GBs) in the vector memory pool. Reserving that much memory is often not practical, especially in serverless and multi-tenant environments like Oracle Autonomous Database Serverless (ADB-S). In an ADB-S, a tenant is a customer who pays for storage and compute instances in the cloud, where a compute instance corresponds to time, memory, and processors.

The vector index must be sized accurately to allocate the proper area in the memory pool for the vector index. However, sizing the vector memory pool is difficult because the user needs to guesstimate the size of their vector index. For example, the initial sizing is difficult at least in part due to ongoing changes in size of an HNSW index that has a multiple gigabyte to multiple terabyte footprint.

Also, precious SGA memory needs to be provisioned up front, such as by an administrator specifying an allocation for the vector memory pool in the SGA based on the size of the vector index. Reserving a guesstimate is not efficient because the memory may be allocated but not used.

Additionally, on ADB-S, vector search workloads need to co-exist with OLTP and Online Analytical Processing (OLAP) workloads which need SGA memory for buffer cache, shared pool, and in-memory area. Also, space from the vector memory pool needs to be reclaimed for use by other SGA components when (1) the database resources are scaled down, (2) the vector search workload stops, (3) the index is dropped, or other situations. If space reclamation leads to insufficient available space for an active index, then the index must be removed, which makes the index unusable, even when only a small amount of space must be reclaimed, and results in slower queries that are performed on the base table. Thus, smart eviction strategies are needed to avoid fully evicting the index, which otherwise leads to a dropoff in the performance of user AI workloads.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is a block diagram that depicts an example vector database management system (VDBMS) according to an example embodiment.

FIG. 2 is a diagram that depicts an example logical representation of an HNSW index that comprises four layers according to an example embodiment.

FIG. 3 is a block diagram that depicts an example storage architecture for storing an HNSW graph according to an example embodiment.

FIG. 4 is a block diagram that depicts an example organization of an example HNSW index according to an example embodiment.

FIG. 5 is a block diagram that depicts an updated version of an HNSW index after multiple inserts have been made into that index according to an example embodiment.

FIG. 6 is an illustration of refreshing an HNSW index according to an example embodiment.

FIG. 7 is an illustration of incremental snapshot creation according to an example embodiment.

FIG. 8 is an illustration of snapshots and segments according to an example embodiment.

FIG. 9 is an illustration of an SGA granule according to an example embodiment.

FIG. 10 is an illustration of relocating segments to available granules using a copy on write mechanism according to an example embodiment.

FIG. 11 is an illustration of a layout of the vector pool resident cached centroids according to an example embodiment.

FIG. 12 is a flowchart of a method for elastic vector index memory pool size for a vector database according to an example embodiment.

FIG. 13 is a flowchart of a method for elastic vector index memory pool size for a vector database according to an example embodiment.

FIG. 14 is a block diagram that illustrates a computer system upon which aspects of the illustrative embodiments may be implemented.

FIG. 15 is a block diagram of a basic software system that may be employed for controlling the operation of a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As discussed above, sizing the vector memory pool is difficult because the user needs to guesstimate the size of their HNSW indexes. Also, precious SGA memory would be provisioned upfront, such as by an administrator specifying an allocation for the vector memory pool in the SGA.

It is more efficient to allow the vector memory pool to elastically grow and shrink on-demand. The illustrative embodiments provide elastic vector index memory pool size for a vector database. For example, embodiments provide mechanisms to automatically grow the vector memory pool, such as from scratch, and also to automatically shrink the vector memory pool to handle both normal and forced memory reclamation. The elasticity of the vector memory pool improves the operations of a computer and a database by providing faster and periodic adjustment of the memory pool size, and also by allocating storage more efficiently, which saves memory. Further details are provided below.

### SGA Memory Granules

The SGA memory is a shared memory, which means any process can access that piece of memory. The SGA memory is organized in chunks. Each of these chunks is considered a granule, which is a unit of allocation that has a fixed size in the SGA. When the database starts up, the database decides the ideal granule size, such as 64 MB, which is a typical granularity.

The reason for the concept of granules is because there are many different dedicated components within the SGA. The components can include a buffer cache, a shared pool with the SQL cursors, a Java Pool, and other components. All the components need space from the SGA. The granule is the currency that is used to transfer space between all these SGA components. Thus, if the buffer cache needs more space, it requests a granule that may be taken from another component, such as the shared pool. If a granule is taken from the shared pool, then the SQL cursors in the granule are evicted. Any SQL that is affected must be recompiled.

Similarly, when the vector memory pool needs space, it may take granules from another component, such as the buffer cache. All the buffers in those granules are removed and the granules are repurposed for the vector memory pool usage.

Thus, a granule can be considered a chunk of memory that is being used as a currency for transferring vector pool memory between different SGA components. The granules may not be contiguous, so a vector index may take the job of stitching data structures across granules for the vector memory pool.

### Segments and Snapshots

Vertices of an HNSW index can be organized into segments. AN HNSW index is an in-memory multi-layered graph-based index. The HNSW index can have multiple snapshots. Each snapshot tracks changes as of a particular time. When new changes come in, another snapshot can be created. Top level metadata can track different snapshots that have been taken at different times. Each snapshot corresponds to a multi-layered graph, such as a graph with layer 0, L0, layer 1, L1, and layer 2, L2. Each layer of the graph tracks a set of vertices and the neighbors for that set of vertices. The tracked vertices can be organized into segments of vertices, such as one segment, S1, for vertices V1 to V5 and another segment, S2, for vertices V6 to V10, etc. Thus, each segment corresponds to a particular set of vertices and corresponding neighbors, per layer, per snapshot of the index. Organizing the layers into segments allows for efficient management, movement, and relocation of the segments.

For example, each granule can have different segments from different HNSW indexes. If a granule needs to be evicted, the granule can be identified as corresponding to certain segments of certain layers of certain snapshots of a certain index. This identification can allow a granule with segments to remain online for reading while the segments are being moved to a new place until the granule is eventually purged to reclaim the corresponding memory space.

### Vector Index Creation and Sizing

A database instance (which may have multiple tenant databases) will start with 0 bytes of SGA provisioned to the vector memory pool. This can allow a system to operate more efficiently because unnecessary memory is not wasted on the vector memory pool. Also, the system does not need to know a priori whether or not the database instance will include a vector index and can wait until the tenant creates a vector index to provision SGA memory for the vector memory pool. This saves memory for use by other components.

Each tenant database has an SGA quota and can create a new HNSW index up to that memory limit. When a new HNSW index is created, the vector memory pool will grow automatically to accommodate the HNSW index. The size of the index can be estimated based on a vector storage that stores the vectors, based on a mapping table that maps row identifiers to vector identifiers, based on a vertex vector map, based on the in-memory multi-layer neighbor vector graph, based on auxiliary metadata, and/or based on other factors.

The vertex vector map is the in-memory storage of vectors organized by vertex IDs. The size of this map is the number of dimensions in each vector times the size of each dimension value (e.g. 4B for FLOAT32) times the number of vectors.

The in-memory multi-layer neighbor vector graph is the actual graph structure of the HNSW index. The lowest layer has all the vertices, and each vertex has 2M neighbors (where M is a tunable parameter). The lowest layer dominates the graph size. Higher layers have a decaying fraction of vertices.

The auxiliary metadata includes the space needed to map vertex identifiers (e.g., each 8B) to base table row identifiers (e.g., each up to 10B), where the base table of vectors has the vertices that are indexed by the HNSW index.

A vector index can have multiple snapshots based on the transaction throughput. Each snapshot has a fixed set of layers based on a probability distribution, that is a function of the number of vertices and the number of edges of the vector index. Each layer has a subset of vertices, where the lowest layer has all vertices. As an example, the layer above the lowest layer may have 100th of those vertices, the layer above may have 100th of those vertices, etc.

Every vector is stored in memory to provide faster access than disk storage. The vectors can be relatively large, such as 4 kB based on the machine learning model that generated the vector index. Neighborhood arrays are also stored in memory. As an example, the neighborhood arrays can include 4 Byte or 8 Byte vertex identifiers. Row identifiers are also stored in memory, where the row identifiers link the vertex identifiers in a given layer to the base table. The size of the vector index for storage is based on all the table data within the layers.

### Vector Memory Pool Growth

Once the vector index size is estimated and the number of needed SGA granules is known, the size of the vector memory pool is increased to store the vector index. The granules may be available or may need to be taken from other SGA components. An SGA granule may store information from multiple vector indexes.

Embodiments can provide improved memory storage and faster operations because the growth of the vector memory pool space to fit the vector index before the vector index is created provides locality of the vector indexes within a set of SGA granules. For example, if there is a large amount of space that is shared by multiple databases and the databases start creating vector indexes, it is likely that the space search algorithm will spread out the vector index over a large number of granules. Because embodiments grow the vector memory pool for a particular vector index, the probability that the vector index would be co-located within a newly acquired set of SGA granules is very high, which provides for improved memory storage and access.

### Conditions for Vector Memory Pool Granule Release

In order for the vector memory pool to be elastic, memory space is both acquired and released. The vector memory pool space is released based on various conditions that return SGA granules back to other components, such as the buffer cache.

For example, when the HNSW index is dropped, the space occupied by the index in the vector memory pool is released. Also, when the vector memory pool decreases in size, granules are returned for use by other components and other databases.

In another condition, when the database resources are scaled down (e.g., a user's SGA quota is decreased), the vector memory pool usage should be scaled down proportionately. Smart HNSW index eviction can be performed. For example, the SGA memory can be shared by multiple databases, not just by components of one database, because the SGA memory can be a global multi-tenant resource. When a tenant decides to reduce their resources, such as to save cost, the resources are scaled down and the vector memory pool usage is scaled down accordingly.

In another condition, when a tenant database is closed, the vector memory pool usage by the tenant database must be released. For example, tenants can open and close databases often on the cloud, where a tenant may close their database to cut costs. Also, a database may have been used for a specific purpose and the database is no longer necessary once that purpose is served. Then, the database is closed, and the vector memory pool shrinks accordingly.

In another condition, when the database is restarted, the vector memory pool proactively grows to accommodate existing HNSW indexes. Then HNSW indexes are automatically reloaded either from a checkpointed copy, like a snapshot stored on disk, or rebuilt from scratch from the base table. For example, a database may be closed and later reopened. When the database closes, the corresponding vector memory pool shrinks, such as to zero. When the database is reopened, the vector indexes are recreated, and therefore the vector memory pool grows to accommodate the recreated vector indexes.

### Vector Index Eviction

Smart vector index eviction minimizes the chances of full index eviction. Eviction can happen when the tenant database size changes. In addition, when other tenant databases are resized or closed, the resulting vector memory pool shrink may release non-empty SGA granules containing index allocations from active databases. Smart vector index eviction and repopulation can ensure the remaining indexes in the non-empty granules do not suffer from full eviction.

In a possible embodiment of smart vector index eviction, a set of victim granules is identified for deletion to satisfy the reduction in memory footprint for the vector memory pool shrink. New space is found in other granules to relocate the victim allocations of the corresponding HNSW index. If there is insufficient space, then full HNSW index eviction may be required.

Also, certain snapshots can be evicted instead of the whole HSNW index. In this process, the HNSW index snapshots that exist in the victim granules are identified as victim snapshots. Then, the HNSW metadata is updated to point to other snapshots, such as more recent snapshots, to allow eviction of the victim snapshots. Before evicting the victim snapshots, active readers are drained. A “tick-tock with refcount” approach is used to switch new readers to the other snapshots, while waiting for the refcount of the number of readers on the victim snapshots to reach zero.

### Voluntary and Involuntary Vector Memory Pool Shrink

The vector memory pool may shrink for a variety of reasons. For example, there can be voluntary and involuntary shrinking of components in the cloud.

### Voluntary Shrink

In a voluntary scenario, a user may want to reduce their cost and pay for fewer resources, which has the effect of scaling down memory and the reduction of the amount of SGA space available for their vector index. Corresponding actions may be taken into account for the reduced availability, which may result in evicting the entire vector index. Victim granules for eviction can be selected to minimize the amount of eviction when the memory availability is scaled down. For example, granules with a lot of free space are better candidates as victim granules.

### Involuntary Shrink

Involuntary shrinking of the vector memory pool can result from the oversubscription of a cloud database. For example, the number of consumers may result in exceeding available resources. In most cases, oversubscription is acceptable because most consumers tend to be idle. However, issues may arise when an excessive number of consumers start using the memory at the same time. In this case, a vector memory pool may be involuntarily shrunk to avoid technical complications from overuse of the SGA memory. Embodiments can manage the vector memory pool size in an efficient manner regardless of whether it shrinks voluntarily or involuntarily.

### Embodiment Outcomes

Embodiments can provide for elastic space management for in-memory data, such as neighbor graph vector indexes in an autonomous database. Embodiments can further provide for efficient vector memory pool growth that avoids fragmentation of space and does not use more space than needed.

Embodiments can also provide algorithms for shrinking the vector memory pool memory containing allocations from different vector indexes. The algorithms can provide total eviction of vector indexes, partial eviction of HNSW snapshots, and other aspects for shrinking the vector memory pool. Embodiments can also provide efficient vector memory pool shrink strategies that do not disrupt ongoing user queries. For example, algorithms can shrink the vector memory pool to recover space in the SGA memory while keeping the HNSW indexes online to avoid queries slowing down due to the HNSW index being offline. Embodiments can further provide algorithms for efficient relocation of HNSW index allocations when SGA granules are de-allocated.

Some embodiments are explained using an HNSW index as an example, but many embodiments are also applicable to other vector indexes, such as an IVF index. For example, embodiments can provide elastic space management for keeping the centroid vectors for an IVF index in memory. Thus, the embodiments may refer to vector indexes generally and may refer to HNSW and IVF indexes as examples.

In a possible embodiment, the size of a neighbor graph vector index can be estimated. The neighbor graph vector index can be an index of neighbor vertices for a graph-based approximate nearest neighbor search in a vector database. A vector memory pool size of a vector memory pool in a database instance memory can be determined based on the estimated size of the neighbor graph vector index. The database instance memory contains data and control information for a database instance. The neighbor graph vector index can be stored in the vector memory pool. An operation affecting available space in the database instance memory can be detected. The vector memory pool size can be automatically adjusted in response to detecting the operation.

In a possible embodiment, a vector index can be stored in a vector memory pool with a vector memory pool size in a database instance memory. The vector index can be an index of vectors in a vector database. The database instance memory can contain data and control information for a database instance. A first operation on the vector index that affects available space in the database instance memory can be detected. The vector memory pool size can be increased in response to detecting the first operation on the vector index. A second operation of a process can be detected. The second operation can affect the vector memory pool size. The vector memory pool size can be decreased in response to detecting the second operation.

Embodiments can automatically adjust a vector memory pool for one or more HNSW indexes based on space requirements for multiple components of an SGA of a database, based on a changing resource allocation for a database, such as a pluggable database (PDB), based on a changing oversubscription of a database, such as a PDB or a container database (CDB). For example, a CDB is a single database that contains multiple PDBs, while a PDB is a self-contained database within a CDB. Memory usage is fluid, so aspects relating to a PDB can also relate to a CDB and vice versa.

### Vector Database System Overview

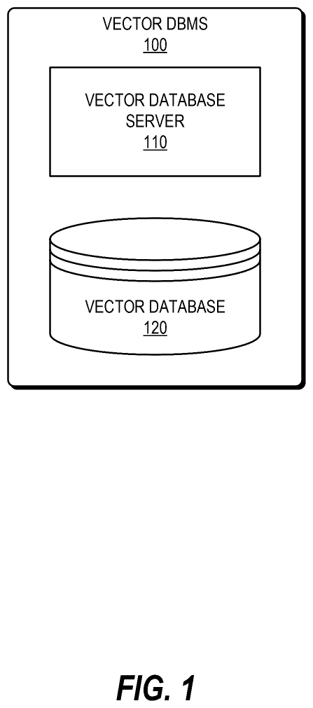

FIG. 1 is a block diagram that depicts an example VDBMS 100 according to an example embodiment. VDBMS 100 includes a vector database server 110 and a vector database 120. The vector database server 110 is communicatively coupled to the vector database 120. VDBMS 100 may be deployed in a network of an enterprise or may be deployed in a cloud environment and, therefore, may be accessible to an enterprise over one or more computer networks (e.g., the Internet). VDBMS 100 may be provisioned for an enterprise by a cloud management team of a cloud provider as needed on an enterprise-by-enterprise basis.

Vector database server 110 includes one or more computing machines, each executing one or more compute instances that receive and process data requests, including data retrieval requests (e.g., queries) and data modification requests (i.e., for vector data modifications), such as inserting vectors, deleting vectors, and updating vectors. A computing instance translates a data request into a storage layer request that the computing instance transmits to vector database 120. A computing machine that hosts at least one compute instance includes (1) one or more processors, (2) volatile memory for storing data requests (and their respective contents) and vector data that is retrieved from vector database 120, and (3) optionally, non-volatile memory.

Vector database 120 may comprise multiple storage devices, each storing vector data and, optionally, one or more non-vector data. For example, vector database 120 stores a table that includes a column for storing vectors and one or more columns for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

Vector database 120 may also store one or more indexes that index content in vector database 120, such as content stored in one or more base tables. Some of the indexed content may be vector-related data (e.g., actual vector embeddings and metadata thereof) and some of the indexed content may be non-vector-related data, such as content in columns that do not store vectors. Thus, at least one index that vector database 120 may store is a vector index, described in more detail herein.

### Vector Queries

A “vector query” is a query that targets one or more vectors in a vector database, such as vector database 120. Vector database server 110 receives a vector query, generates an execution plan for the vector query, and processes the execution plan in order to retrieve one or more vectors from vector database 120. A vector query typically includes a “query vector” and, optionally, one or more other search criteria. A query vector is a vector that vector database server 110 uses to identify one or more vectors in vector database 120. Examples of one or more other search criteria include dates, numbers, strings, etc. For example, a vector query may ask for the top five matching vectors that are associated with the state of California and a date range between Feb. 1, 2024 and Mar. 5, 2024. Such other search criteria may comprise data from columns that are part of the same table that includes the vector column that stores the vectors that the vector query targets.

In order to identify vectors that are similar to a query vector, vector database server 110 may compare the query vector to each vector stored in vector database 120. However, comparing a query vector to each vector in vector database 120 may take a significant amount of time and users are not willing to wait in order to receive an answer. Also, performing such a naïve scan of vector database 120 given a query vector may require a significant amount of computer resources that could be used for other tasks. To address these problems, a vector index may be generated and used in query vector processing.

### Vector Indexes

Currently, similarity searches are often performed on data sets with billions of vectors (i.e., vector embeddings). For example, the Deep1B dataset contains 1 billion images generated by a Convolutional Neural Network (CNN). Computing VECTOR_DISTANCE with every vector in the corpus to find Top-K matches at 100% accuracy is very slow. As a result, approximate vector indexes are used to trade off search quality (recall/accuracy) for search speed.

Vector indexes tend to group data based on vector similarity with the search restricted to a few groups, achieving significant data pruning. Vector similarity is defined in terms of vector_distance( ) calculations. A goal is for a vector index to fit in memory (as opposed to only in slower, long-term (e.g., non-volatile) storage, such as disk) to allow for fast traversals and scans. With modern techniques and memory capacities, an index for billions of vectors can fit into volatile memory. Memory in modern computing machines is large enough for all but the largest workloads of giant web companies.

Two types of vector indexes that may be used to index vectors include HNSW and IVF. HNSW is an in-memory graph that is fast and relatively accurate, but it is larger in size than IVF. IVF is slower and less accurate, but it is smaller in size. Product Quantization (PQ) is a lossy compression technique that may be used to reduce the size of a vector index so that the index may fit into memory or be scanned faster. However, a tradeoff of PQ is lower accuracy. HNSW and IVF may be combined (with or without PQ) to optimize both speed and size.

### Vector Index: IVF

An IVF index is based on K-means clustering or partitioning. A K-means clustering algorithm is applied to a set of vectors to generate K partitions. The value of K (or the number of partitions) may be based on the number of vectors. For example, K=sqrt(N), where N is the number of vectors. Each partition is identified by a centroid, which is a value that is conceptually the average of the vectors that are assigned to that partition. The centroid of a partition may be considered the “center of gravity” of the partition. A goal in determining a centroid is to minimize the total distance between vectors within a partition and their centroid, so that each centroid is a good representative value for its partition.

An IVF index includes two types of tables: (1) a centroid table that stores all the centroids of all the partitions; and (2) K partition tables, each of which stores the vectors that are assigned to that corresponding partition based on closeness to the centroid represented by the partition. In a similarity search, given query vector, the centroid table is searched first (referred to as the “first-level search”) to identify one or more centroids that are the most similar to (or have the lowest distance to) query vector. Thus, either only a single centroid is selected from the centroid table or multiple centroids are selected from the centroid table. The number of centroids to select may be a default value (e.g., two) and/or may be based on vector distance from the query vector. (For example, select the closest three centroids that are within D vector distance from the query vector). Then, for each selected centroid, the partition to which that identified centroid belongs is searched to identify one or more vectors. This search is referred to as a “second-level search.” If the query vector is for the Top K, then the Top K vectors in each identified partition are identified and then the Top K from the Top K of each identified partition are selected.

### Vector Index: HNSW

An HNSW index is a multi-layer in-memory graph index that has relatively high speed and accuracy relative to IVF and other vector indexes. The graph index comprises vertices, each vertex corresponding to a vector. The lowest layer of the graph contains vertices of all of the vectors in the indexed data set. Higher layers of the HNSW index have a decaying fraction of the vertices in the layer below. In each layer, vertices are connected to their approximate M closest neighbors using edges that are used to walk the graph. At the lowest layer (“layer 0”), the number of neighbors of each vertex may be different than the number of neighbors of each vertex at higher layers, such as 2M. The vertices at higher layers are on average much farther from each other (relative to lower layers) and, therefore, allow traversal of long distances.

Two major parameters for HNSW index construction are M and R. “M” is referred to as the “neighbor count” and is the number of neighbors that each vertex is connected to on each layer. Layer 0 (the lowest layer) may have double that number (e.g., 2M neighbors). A probability distribution function may be defined based on M in order to determine whether a vertex is to be inserted in a layer that is above the lowest layer. The probability distribution function is such that probabilities decay with higher layers. When the probability drops below 1e-9, then no more layers are added. An example probability distribution function is

$$p ( Layer ) = ( 1 - 1 / M ) / M \hat{} layer$$

Regarding parameter R, when a new vertex (corresponding to a new vector) is inserted into an HNSW index, a random number R between [0.0, 1.0] is generated. A new vertex is always inserted into layer 0. A new vertex is inserted into higher layers up to layer “i” if:

$$R > p ( i - 1 ) + p ( i - 2 ) … + p ( 0 )$$

In an example, with M=10, if R=0.991, then the new vertex is inserted in layers 0 and 1.

An HNSW parameter that is used only for construction is referred to as “efConstruction” and refers to the number of vertices to consider within a layer when looking for the closest M vertices (or closest 2M vertices in layer 0) to which to connect a new vertex. Larger values for this parameter improve index quality but slow down construction. An example value for this parameter is 2M (or 4M for layer 0).

An HNSW parameter that is used in searching is referred to as “efSearch” and refers to the number of vertices to remember in each layer when searching for the K nearest neighbors in a top-K search. Larger values of this parameter improve search quality but slow down searches. An example value for this parameter is 2*K (or double the number of desired K matches).

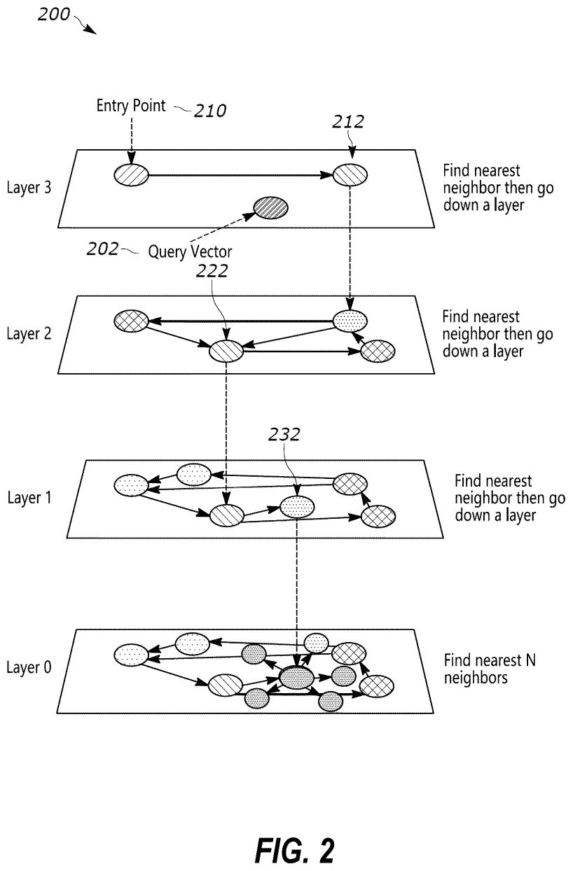

FIG. 2 is a diagram that depicts an example logical representation of an HNSW index 200 that comprises four layers according to an example embodiment. An index search begins from an entry vertex 210 in the top layer (layer 3) and traverses edges looking for the vertex, in that layer, whose vector is nearest query vector 202. If M is 32, then 33 distance calculations are performed between query vector 202 and (i) the vertex of entry vector 210 and (ii) 32 neighbors of entry vector 210. The search process does not only consider neighbors of the entry vector 210, the search process finds the closest neighbor and computes distances for its neighbors as well. This process continues until all the neighbors of a vertex are further from the query vector than the vertex that was used to arrive in that neighborhood. Once the closest vector to query vector 202 in a layer is found (i.e., vertex 212 in this example), the search continues starting with that vertex in the next layer down. This process repeats for each intermediate layer of HNSW index 200. (Thus, vertex 222 is selected in layer 2 and vertex 232 is selected in layer 1.) The index search completes in the lowest layer (i.e., layer 0) by considering the (e.g., 2M) neighbors of vertex 232, in the lowest layer, whose vectors are closest to query vector 202.

For traversing the lowest layer, two heaps are maintained: a candidates heap and a Top K heap. The candidates heap stores vertices that are candidates for further exploration and are ordered based on the distance to the query vector. The Top K heap stores the current best Top K result set so far. The Top K heap holds efSearch vertices. The search proceeds as follows. Vertex 232 is at the top of the candidates heap and all its 2M neighbors are below it in the candidates heap, ordered by distance to query vector 202. Vertex 232 is selected and compared against all vertices in the Top K heap (which is initially empty). The goal is to check whether a vertex popped from the candidates heap can beat the worst vertex (in terms of distance to the query vector) from the Top K heap (which is also a priority queue ordered in reverse, i.e. furthest vertex among the efSearch vertices is at the top of the Top K heap). If the best candidate vertex beats the worst vertex from the current Top K heap, then the best candidate vertex is added to the to the Top K heap and the worst vertex is removed from the Top K heap. The search continues, meaning more candidates are explored. When vertex 232 is selected, the Top K heap is empty, so vertex 232 is automatically added to the Top K heap.

In a scenario where the Top K heap is full (i.e., it contains efSearch vertices), when a vertex V is selected from the candidates heap, the worst vertex in the Top K heap is replaced by V if V beats that worst vertex. All neighbors of V are then added to candidates heap and ordered within the candidates heap, and the next best vertex in the candidates heap is selected and the search continues. The search terminates if the current best candidate in the candidates heap cannot beat the worst vertex in the Top K heap. Increasing efSearch gives accuracy because it is more likely for a candidate vertex to be better than the worst vertex in a set of one hundred vertices in the Top K heap than for the candidate vertex to be better than the worst vertex in a set of ten vertices. Thus, with larger values of efSearch, the exploration goes on longer.

### Vector Index: HNSW Sizing

HNSW is good to use (compared to IVF) if the HNSW index fits in the memory of one server or computing device. The size of an HNSW index is dominated by layer 0 (higher layers decline rapidly.) Layer 0 includes a vertex for each indexed vector and two vector identifiers (referred to herein as “VIDs”) for each edge connecting two vertices. Each VID may comprise four bytes.

For N vectors of size S with M neighbors each, the index size may be computed as follows:

$$Index Size = Total Size of Vectors + Total Size of Edge Metadata = N * ( S + M * 8 )$$

The following table shows sample index sizes for an HNSW index that is based on one hundred million vectors.

| # of Dimensions | # of Neighbors | Index Size (GB) |
|---|---|---|
| 512 | 16 | 203 |
| 512 | 32 | 215 |
| 512 | 64 | 239 |
| 1024 | 16 | 394 |
| 1024 | 32 | 406 |
| 1024 | 64 | 430 |
| 2048 | 16 | 775 |
| 2048 | 32 | 787 |
| 2048 | 64 | 811 |

Thus, for a server with two terabytes of memory, the maximum number of vectors the server can store are approximately one billion vectors (of 512 dimensions each, each vector with 32 neighbors), five hundred million vectors (of 1024 dimensions each, each vector with 32 neighbors), and two hundred and fifty million vectors (of 2048 dimensions each, each vector with 32 neighbors).

### HNSW: Example Storage Architecture

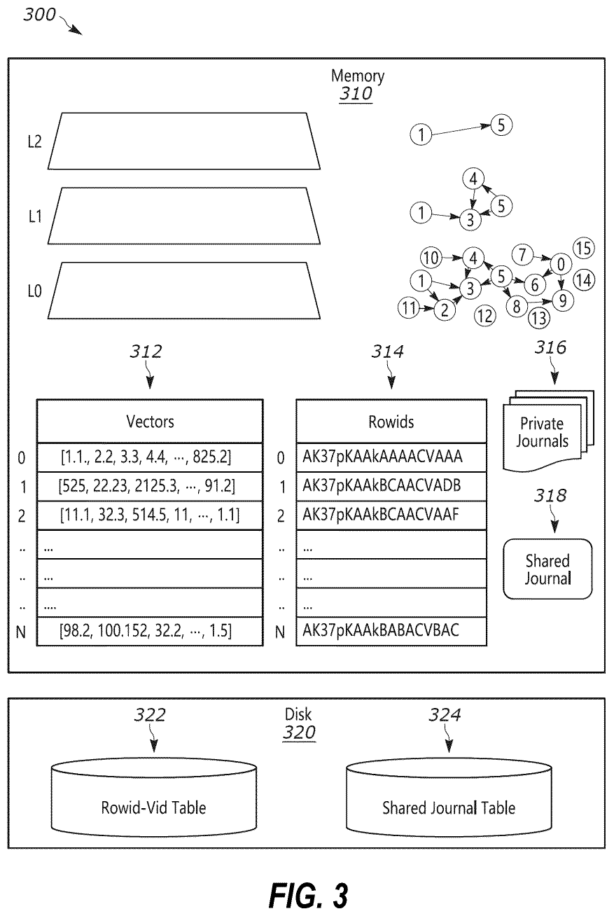

FIG. 3 is a block diagram that depicts an example storage architecture 300 for storing an HNSW graph according to an example embodiment. Storage architecture 300 includes memory storage 310 and disk storage 320. Memory storage 310 is part of vector database server 110 and may be on a single compute instance or may represent the memory of multiple compute instances. Similarly, disk storage 320 is part of vector database server 110 and may be part of a single compute instance or may represent persistent storage of multiple compute instances.

Memory storage 310 stores layers 0-2 of an HNSW index along with a vertex vector map 312 (which is different than the base table), rowid table 314, private journals 316, and shared journal cache 318. Vertex vector map 312 comprises multiple rows, each row containing a vector and each row being associated with an index value that uniquely identifies a position within vertex vector map 312. Rowid table 314 comprises multiple rows, each row containing a row identifier and each row being associated with an index value that uniquely identifies a position within rowid table 314. The index position is the VID.

Multiple private journals 316 indicate that there are multiple pending transactions that have not yet committed, each private journal corresponding to a different pending transaction. Private journals 316 store data about vector modifications that are initiated by DML (data manipulation language) statements, such as inserts, deletes, and updates. Each of the private journals 316 exists as long as a vector modification has not yet committed. At commit, one or more changes initiated by a DML statement are stored in shared journal table 324 in disk storage 320 (and, optionally, in shared journal cache 318) Periodically, or in response to certain events occurring or one or more criteria being satisfied, the contents of shared journal table 324 are applied to the HNSW index and vertex vector map 312. Thus, shared journal table 324 allows changes to the HNSW index to be buffered and to be applied to the HNSW index at a later time. Shared journal table 324 may also be used to allow “as of” vector queries, which is a vector query that asks for the state of the vector data “as of” a particular point in time in the past, but after the build/creation time of the HNSW index.

Shared journal cache 318 (1) enables transactionally consistent queries involving vector search, (2) allows for delayed maintenance of the HNSW index, and (3) provides persistence for unapplied changes to the HNSW index, which enables faster restart after a compute instance crashes. Regarding (1), the HNSW index and the shared journal cache 318 (and private journals 316 for in-transaction queries) always contain the changes to the set of indexed vectors since the creation of the HNSW index. Regarding (2), the HNSW index is best maintained in large batches of changes, and shared journal cache 318 acts as a buffer of changes, thus, giving flexibility in the timing of HNSW index maintenance operations. Shared journal cache 318 may also be used for journaling during online creation of the HNSW index. Regarding (3), the HNSW index may be periodically persisted to persistent (non-volatile) storage using a checkpoint mechanism. Also, because shared journal cache 318 is persisted to shared journal table 324, changes are guaranteed to be persisted from the HNSW checkpoint System Change Number (SCN) to the latest committed vector changes. Thus, upon restarting a compute instance after a crash, the HNSW index may be restored to memory from the checkpointed image, and the changes from shared journal table 324 may be applied to the restored image in a lazy manner.

Disk storage 320 also stores ROWID-VID table 322, which is a mapping table that maps rowids to vector IDs. The mapping table may be used to identify vectors that are deleted or those vectors that pass an attribute filter. One reason for using VIDs instead of rowids in a vector index is because VIDs are much smaller in size than rowids.

### HNSW: Example Data Implementation

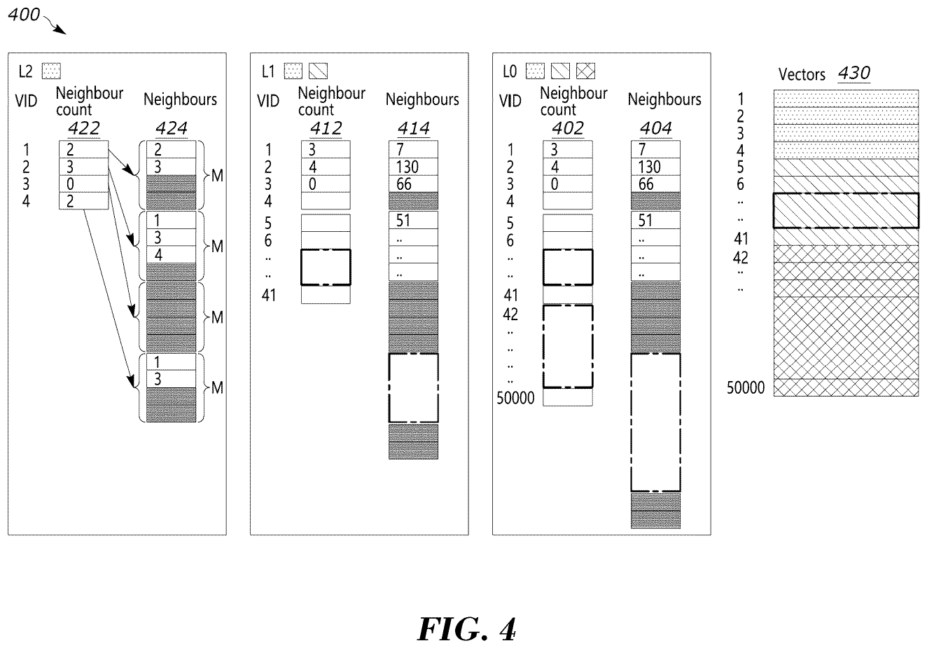

FIG. 4 is a block diagram that depicts an example organization of an example HNSW index 400 according to an example embodiment. In this example, HNSW index 400 comprises three layers, layers 0-2. Each layer stores data about a set of vertices and contains a neighbor count array for the set of vertices and a neighbors array for the set of vertices. Thus, layer 2 includes a neighbor count array 422 and a neighbors array 424. Each entry in neighbor count array 422 corresponds to a different vector that has been assigned to layer 2. Each position of neighbor count array 422 is an index value that points to a position within vectors array 430, which stores vector embeddings for the vertices in layer 0. Thus, the first position in neighbor count array 422 corresponds to the vector in the first position of vectors array 430, the second position in neighbor count array 422 corresponds to the vector in the second position of vectors array 430, and so forth. The same is true for neighbor count array 412, neighbors array 414, neighbor count array 402, and neighbors array 404. As FIG. 4 indicates, the number of vertices assigned to each layer increases from the top-most layer to the bottom-most layer. Also, a vertex that appears in a top layer (e.g., vertex with VID 1) or in an intermediate layer also appears in each layer below that layer.

In an embodiment, vectors array 430 is constructed by assigning VIDs to vertexes during their respective insertion into a layer of HNSW index 400. Thus, the vertices (and, thus, their corresponding vectors) that are assigned to the highest layer will have lower VID/position numbers (and will be inserted first into HNSW index 400) relative to vertices that are assigned first to a lower layer.

Each entry in neighbor count array 422 includes a value that indicates a number of neighbors that the corresponding vertex has been assigned during the index construction phase. Each (“referencing”) entry in neighbor count array 422 also references or points to an (“referenced”) entry in neighbors array 424 where at least one neighbor of the corresponding vertex is identified. That referenced entry may be the first entry of a set of entries that correspond to the neighbors of the referencing entry. Because each vertex has at most M neighbors, the remaining neighbors of the corresponding vertex are listed in entries subsequent to that first referenced entry, up to M−1 entries away from the first entry. As the example of FIG. 4 indicates, some vertices may have less than M neighbors.

Neighbors array 424 includes vector IDs of neighbors of vertices indicated in neighbor count array 422. While neighbors array 424 is presented as a single array, neighbors array 424 may be implemented as a single array or as multiple smaller arrays (e.g., of size M) but are concatenated together for ease of description.

### HNSW: Updates to HNSW Index

After an HNSW index is built, one or more changes may be made to the underlying vector data. Such changes may be initiated by DML statements. One way to process the one or more changes is to buffer those changes by storing the changes in a separate table, such as shared journal table 324. Eventually, it becomes necessary to apply those changes to the HNSW index. Another way to process the one or more changes is to apply the changes immediately to the HNSW index, without buffering. However, immediately applying changes made by a transaction means that the transaction “pays” the overhead of maintenance, thus slowing down the transaction. Regardless of which approach is used to process changes, whether in batches or incrementally as the changes are received, it is preferred to not rebuild the HNSW index “from scratch,” since that is an expensive operation in terms of time and resources.

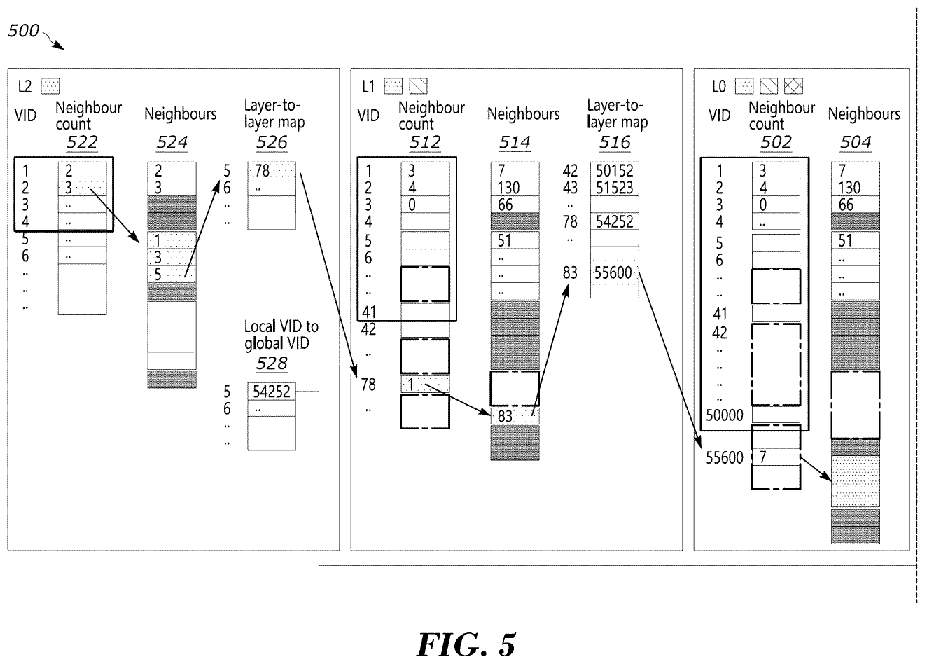

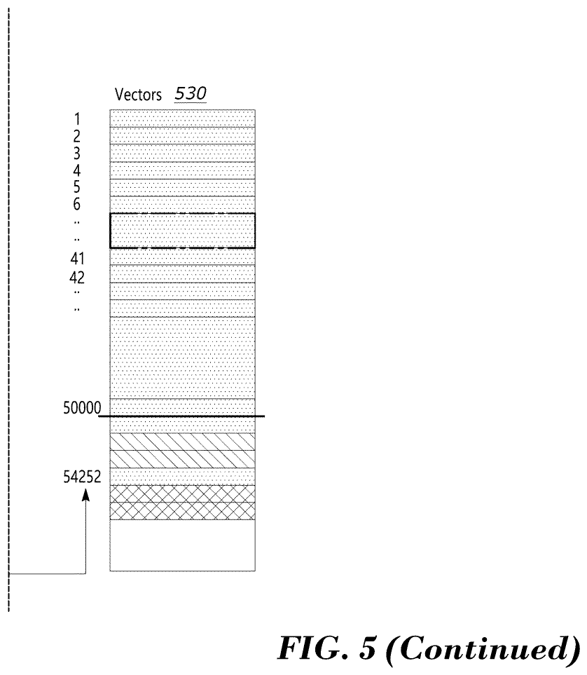

FIG. 5 is a block diagram that depicts an updated version of an HNSW index 500 after multiple inserts have been made into that index according to an example embodiment. HNSW index 500 is the updated version of HNSW index 400 and includes the same data structures as depicted in FIG. 4 (except with updated reference numerals, such as 504, 514, and 524) as well as additional data structures. Layer 2 (the top-most layer) has layer-to-layer map 526 and local VID to global VID map 528, while layer 1 has layer-to-layer map 516. In response to a batch update or an incremental update, it may be automatically determined (e.g., by an index updating component) that a vertex for the new vector is to be inserted into layer 2. A naïve approach would be to assign that new vertex to the next available VID in vectors array 530 (e.g., 50001) and to use that VID in the other layers of HNSW index 500. However, neighbor count array 522 has a limited number of positions and it would be a waste of space to assign the new vertex to have a VID of 50000+, because then neighbor count array 522 would have thousands of unused entries.

In the depicted embodiment, a new vertex/vector is assigned multiple local VIDs, each for a different layer of HNSW index 500. Thus, the next available VID in neighbor count array 522 is determined. In this example, that next available VID is 5. However, VID 5 is already assigned to another vector in vectors array 530. Nevertheless, the new vector is also assigned the next available VID in vectors array 530, which is, in this example, 54252. Therefore, the new vector has two VIDs: 5 and 54252. In response, local VID to global VID map 528 is updated to associate the “local” VID of 5 (local to layer 2) to the “global” VID of 54252.

Because this new vertex is assigned to layer 2, a vertex of the new vector is also assigned to layer 1. Similarly, because neighbor count array 512 has a limited number of positions and it would be a waste of space to assign the new vertex to have a VID of 54252 in layer 1, the next available VID in neighbor count array 512 is determined. In this example, that next available VID in layer 1 is 78. Although not depicted in FIG. 5, layer 1 also has a local VID to global VID map, as in layer 2, so that vector distances may be computed during a search. Further, in this example, the new vertex in layer 1 has a neighbor (in layer 1) that is assigned VID 83 and, according to layer-to-layer map 516, is mapped to VID 55600 in neighbor count array 502. Thus, presuming that HNSW index 400 had fifty thousand vectors when it was built, the vector assigned VID 55600 was added to the HNSW index sometime after HNSW index 400 was built.

In an embodiment, deletes are not propagated to higher layers. Instead, deleted vertices are masked only in the lowest layer of the HNSW index.

### Multi-Snapshot HNSW Index

As described herein, an HNSW index is a multi-layer in-memory neighbor vector graph built from vectors. The HNSW index is also built as of a specific point in time, which may be determined using timestamps or SCNs. The time at which an HNSW index is built is referred to as the “build SCN.” Thus, an HNSW index may be considered a “snapshot” of the index. As DML statements are applied to the base table of vectors upon which the HNSW index is built, this snapshot becomes stale, leading to slower query performance due to ever-increasing disk-based shared journal access. Therefore, the most recent snapshot eventually should be refreshed. Refreshing a snapshot refers to updating a snapshot based on changes that have been made to the base table of vectors since the build SCN of the snapshot.

There are two approaches for refreshing a snapshot: a tic-toc snapshot approach and a multi-snapshot approach. In the tic-toc snapshot approach, at most two snapshots of the HNSW index are maintained or tracked: the current active snapshot and a new snapshot that is built in the background that eventually becomes visible to vector queries once fully built. Once the new snapshot is available, vector queries that have a timestamp or SCN that is after (timewise) the new snapshot's build SCN are directed to the new snapshot. Vector queries that began to be processed against the old snapshot eventually end (whether terminated due to an error or fully processed with a query result generated). Once a retention threshold has elapsed, it is guaranteed that VDBMS 100 will not receive any vector queries with scan SCN that is less than the new snapshot's build SCN. The old snapshot may be deleted after the lapse of that retention threshold.

In the tic-toc snapshot approach, long-running queries (or even large retention thresholds) can prevent the reclamation (or deletion) of the old snapshot, which also prevents the creation of a newer snapshot since only two snapshots are allowed. The tic-toc snapshot approach may be generalized to a multi-snapshot design where snapshots are periodically created and tracked.

### Multi-Snapshot HNSW Index: Efficient Creation of Snapshots

In an embodiment, snapshots of an HNSW index are created incrementally. This means that snapshot i+1 is created by applying changes in the shared journal that is associated with the HNSW index and, thus, stores changes that have a timestamp that is after the build timestamp of snapshot i. In other words, the changes in the shared journal are associated with timestamps, or SCNs, in the SCN range [Snapshot #i creation SCN, Snapshot #i+1 chosen creation SCN] and are applied to snapshot i. For example, a snapshot creation process (e.g., executing in the vector database server 110) identifies the build SCN of snapshot i, identifies a current SCN that will be the build SCN of snapshot i+1, identifies (in the shared journal) all changes associated with an SCN between those two SCNs, and applies those identified changes to snapshot i (or a copy thereof), resulting in snapshot i+1. Thus, creating a new snapshot from an old (or most recent) snapshot may involve copying the old snapshot (with all its vertices and neighbor lists) and modifying that copy.

There are two main types of changes that are to be accounted for when creating a new snapshot: deletes of vectors and inserts of vectors. (An update of a vector may be implemented as a deletion of the vector followed by an insert of a new vector that replaces the vector.)

### Vector Deletes

Deletes may be handled in one of multiple ways. In a first deletion technique, for each deletion of a vector, a vertex, in the new snapshot, is identified that corresponds to the deleted vector, and that vertex is marked as deleted or masked off. However, the neighbor lists of that vertex remain unchanged. Then, during query execution, a Top K traversal of the new snapshot skips or avoids returning those marked vertices, which process is similar to the handling of the delete filter.

In a second deletion technique, neighbor lists (copied from the most recent snapshot) are adjusted to remove, in the new snapshot, the deleted vertices. Whenever a vertex V is removed, it affects the vertices that had V as one of their 2M neighbors. The set of all such vertices comprises the proximal graph. Thus, a proximal graph comprises (1) a first set of vertices, in a snapshot, that are deleted based on changes indicated in the shared journal and (2) a second set of vertices, in the snapshot, each of which is connected to at least one vertex in the first set of vertices. For each vertex in the second set, an alternate neighbor is chosen to replace V. Alternatively, each vertex in the second set is “re-inserted” into the graph. The insertion algorithm takes care of adjusting neighbor lists.

### Vector Inserts

Regarding vector inserts, inserts are handled using the insertion process described herein. The number of inserts and/or the percentage of all vectors that are inserted may be factors in determining whether to rebuild the HNSW index instead of creating a new snapshot from a current snapshot.

In an embodiment, a copy-on-write technique is used to create new copies of neighbor lists that have been modified. For neighbor lists that have not been modified, the memory from the previous snapshot is shared in the new snapshot. This ensures that the memory overhead of the new snapshot is minimal.

As depicted in FIG. 4, each layer has a neighbor count array and a neighbors array. A neighbor count array is essentially a “source array.” Index 1 in the source array is vertex ID 1, index 2 in the source array is vertex ID 2 and so on. The neighbors array stores up to M (or 2M) neighbors per source vertex. There is a pointer from every source array vertex to its neighbors (specifically, the first of its M neighbors).

With that context, using the copy-on-write technique when creating a new snapshot, a new copy of the entire source array is created in each layer. Essentially, every source vertex “points” to the existing neighbor list (unchanged vertex) or to a new neighbor list (because the source vertex's neighbors have been affected). Because a new copy of the source array is created, each vertex points to its old neighbor lists by default. If the neighbors of a source vertex have changed, then a copy-on-write is performed for the neighbor list of that source vertex. This means that a copy of the M neighbors is created elsewhere, the old deleted neighbors are removed from that copy, new neighbors are added to the copy, and the pointer of the source vertex entry to this copy is updated. Thus, the set of unchanged neighbor lists are pointed to by the source array of snapshot 1 and snapshot 2. This neighbor list memory is shared. For the changed neighbor lists, the source array for snapshot 1 points to a different memory region than the source array for snapshot 2.

In a related embodiment, neighbor lists are broken up into chunks, such as segments, (e.g., of 1 MB), rather than a single contiguous entity of vertices. Within each chunk, if any neighbor list is changed, then a copy-on-write is performed on the entire chunk.

When a snapshot is reclaimed, that region of M neighbors within the chunk may be marked as free, and this memory can be used to perform a copy-on-write on the neighbor list of some other snapshot.

In summary, in response to determining to generate a new snapshot of an HNSW index, a first set of vertices, in the latest (or most recent) snapshot, whose neighbor lists have not changed since that snapshot is identified. Also, a second set of vertices, in the latest snapshot, whose neighbor lists have changed since that snapshot is identified. Memory, for the latest snapshot, that stores neighbor lists of the first set of vertices is shared with the new snapshot. For example, the upper two layers of the two snapshots may be identical and, therefore, completely shared when traversing/scanning either snapshot for different vector queries with different timestamps. Unused memory is allocated for the new snapshot in order to store the updated neighbor lists of the second set of vertices. (The source array is a new piece of memory for each snapshot.) This allocation may involve copying the memory, for the latest snapshot, that stored the neighbor lists of the second set of vertices into the unused memory for the new snapshot and then modifying the neighbor lists so that they no longer include deleted vertices.

### Vector Index Vector Memory Pool Management

Embodiments provide mechanisms to automatically grow the vector memory pool, such as from scratch, and also automatically shrink techniques to handle both normal and forced memory reclamation.

Vector Memory Pool Growth from Index Creation

Some operations the vector memory pool for a vector index, such as an in-memory neighbor graph vector index (HNSW index) or other vector indexes. One operation that grows the vector memory pool is vector index creation. When a vector index, such as an HNSW index/graph, is created, the size of the HNSW index is estimated based on the number of vectors, the size of each vector, and graph parameters, such as number of neighbors, number of layers, and metadata overhead. The vector memory pool grows based on the size of the vector index.

For example, each node in a cluster (e.g., a Real Application Cluster (RAC)) can run one or more compute instances, such as database servers. Each individual node can have its own SGA carved out of the available main memory. One node may not access the SGA area of another node directly. Instead, a node can send network messages to fetch data from the SGA area of another node. Every node grows the vector pool area if they wish to have a copy of the HNSW index. Each compute instance can have a portion of a node's SGA. Each node can be a different machine, and everything is backed up on disk in case a node goes down. Nodes are connected to a database that is shared, and they can read from the same database and pull data into their own memory, perform operations, and send the data back. If the HNSW index is duplicated across nodes in a cluster, then each cluster node grows the vector memory pool using the computed size. Vector index creation may fail if a coordinator node is unable to grow the vector memory pool. However, if a cluster node is unable to grow the vector memory pool, then a background reload can grow the vector memory pool and create the HNSW index. For example, some vector indexes can occupy transient space, such as space taken by journaling that may fluctuate. A process can continue to attempt to grow the vector memory pool in the background and obtain the space for the vector index when the space becomes available. This can improve query throughput by providing more availability because that compute instance is also participating with a particular vector index.

In an example implementation, a node in a multi-cluster node setting can request an index creation, can determine how much size is needed for the vector index, and can pre-allocate the necessary space. Other nodes in the cluster can participate in the index creation and pre-allocate space for the vector index to duplicate the vector index across the cluster. Thus, during index creation, the vector memory pool grows.

Vector Memory Pool Growth from Index Journaling

Another operation that grows the vector memory pool is index journaling. When changes are made, those changes are not directly written into the vector index. Instead, those changes are written into a journaling structure, which occupies space in the vector memory pool, and needs elastic growth to sustain the new upcoming changes, such as inserts, deletes, etc. The new vectors are staged and may not have a neighborhood until added to the vector index at a later time. This journaling may need vector memory pool growth.

For example, new inserts, deletes, and updates of a transaction are tracked in private journal data structures that reside in the vector memory pool. The total footprint of private journals in the instance depends on the transaction throughput on the base table for the vector index and the size of each vector. The private journal stores the vector payload for inserts and updates.

One design involves every DML session growing the vector memory pool based on the number of vectors it is inserting. However, this can lead to multiple small growths and can cause space fragmentation. An alternative operation can have a background process monitor space usage by private journals and determine whether a vector memory pool growth is needed. If growth is needed, then the background process grows the vector memory pool by an appropriate amount derived from the transaction throughput. Techniques such as tracking transaction throughput over a range of time windows (e.g., 10 mins each), creating a scoring function that weighs the throughput rates favoring recent time windows, etc. can be used to better estimate transaction throughput.

Vector Memory Pool Growth from Index Refresh

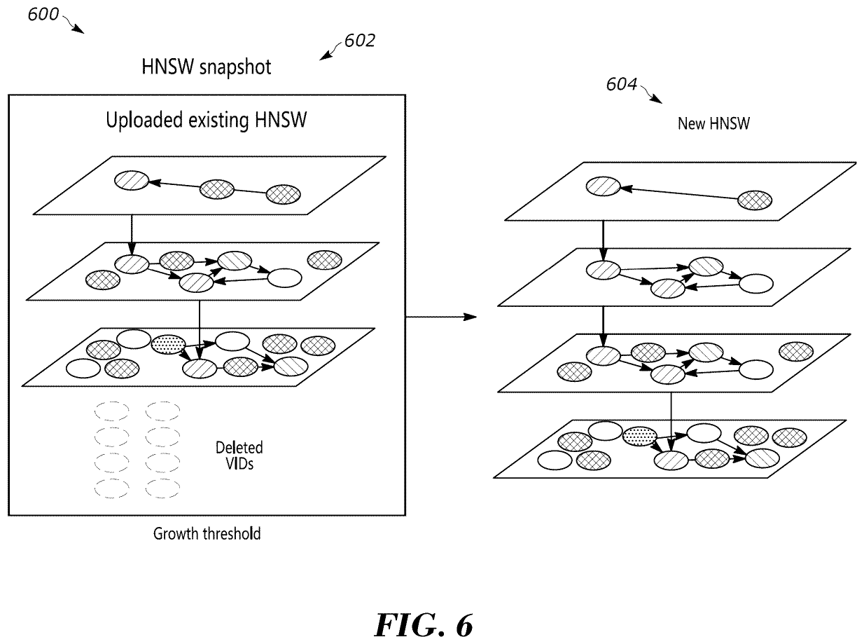

FIG. 6 is an illustration 600 of refreshing an HNSW index according to an example embodiment. The illustration 600 shows a vector index snapshot 602 and a full repopulation of an HNSW index 604 according to an example embodiment. An operation that grows the vector memory pool is vector index refresh. The refresh of the HNSW index refers to the process of indexing the vectors sitting in the journals into the in-memory neighbor vector graph that resides in the vector memory pool. There are different types of refresh operations possible for an HNSW index. One is a full repopulation and the other is incremental snapshots.

### Full Repopulation

A full repopulation is implemented using a double buffering technique where the static HNSW index built as of an older time (older SCN) is available for queries while a new HNSW index is created. Once the new HNSW index is ready, queries can leverage the graph built as of a newer time (newer SCN).

For example, before a vector index is created, queries are made on the base table. The creation of a vector index allows for faster queries via the vector index. After a vector index is created, the vector index remains static and changes, such as changes from DMLs, are tracked in a journal that references the existing vector index. When a full repopulation starts, the existing vector index is maintained for queries from the journals while the new vector index is built.

With a full repopulation, deleted vectors are removed and new vectors are inserted. A full repopulation can provide for better accuracy and higher quality layers because it provides an opportunity to refresh edges. For example, a neighborhood can change due to deleted vectors and new vectors. A full repopulation provides the opportunity to remove deleted vectors and introduce new neighbors that are of better quality. However, a full repopulation can take more time and require more processor usage than incremental snapshots. The full repopulation will also use more memory than incremental snapshots because both the old and the new HNSW index will use memory during the full repopulation. For example, the peak space requirement of a full repopulation can be higher than 2× (double) of the old HNSW index if there are more inserted vectors than deleted vectors. If there are more deleted vectors than inserted vectors, then the peak space requirement can be between 1× and 2× of the old HNSW index.

### Snapshots

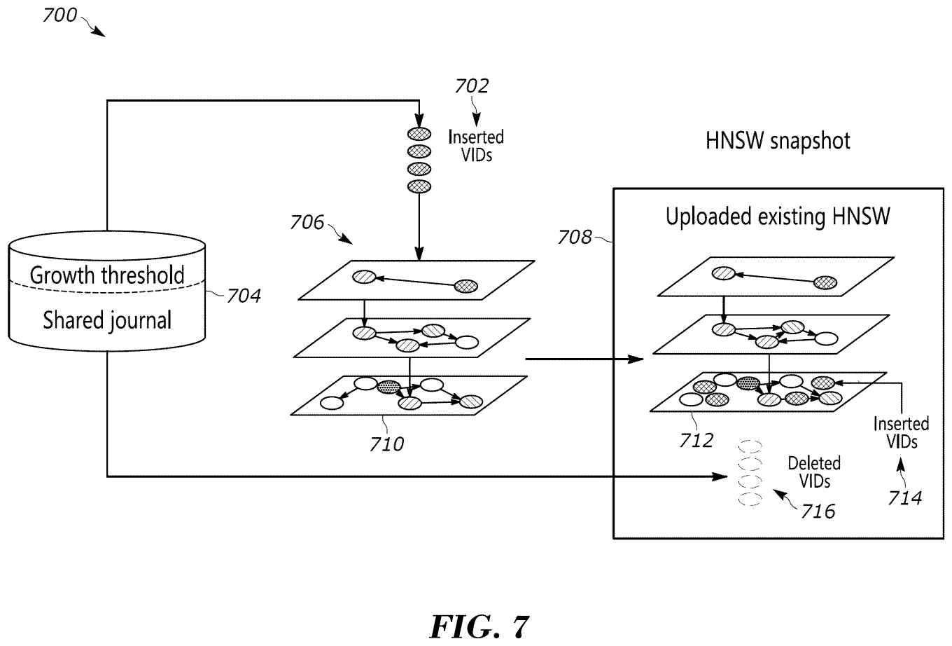

FIG. 7 is an illustration of incremental snapshot creation 700 according to an example embodiment. A full repopulation of a vector index provides a full copy of the old data and there is no dependency on a prior vector index. Snapshots are incremental in nature, which is why they are sometimes referred to as incremental snapshots. Snapshots are built on top of an existing vector index.

As discussed above, snapshot creation of the HNSW index involves adding the newly inserted vectors from a journal into a previous snapshot of the HNSW index (or logically into the HNSW index after a full repopulation) using a copy on write mechanism to create an updated existing HNSW index. Vertices that did not have a change use the same physical space and are referenced by a logical copy that points to the physical space. For example, every incremental snapshot points to the same memory for vertices that have not changed. A copy on write mechanism is used for the vertices that have changed. The changed vertices are marked with the new allocations in the updated existing HNSW index. Thus, the extra space used by an incremental snapshot only corresponds to changes.

Additionally, deleted vectors are not removed. Instead, deleted vectors are tracked in the snapshot using a deleted vertex VID array. The deleted vectors may only add an additional bit to an existing vector that indicates the vector was deleted. When a deleted vector shows up in a search, it is identified as deleted and the search does not progress from the deleted vector.

For example, inserted vectors 702 are applied from a shared journal 704 to an HNSW index or prior snapshot 706 to create an HNSW snapshot 708. As shown, the prior HNSW lowest layer 710 has changed in the HNSW snapshot lowest layer 712 to reflect inserted vectors 714. Deleted vectors from the shared journal are stored in a deleted vector array 716 in the HNSW snapshot 708. The deleted vectors still exist in the HNSW snapshot and are removed when a full repopulation operation is performed. The vertexes that underwent no changes are copied as-is. Segments, described above, that have changed with the addition of vectors are copied and written and a new image is written for the HNSW snapshot. A growth threshold of the shared journal 704 can dictate how often an incremental snapshot is created. The incremental snapshot approach is faster than a full repopulation because the neighborhood selection only needs to be done for a small percentage of vertices.

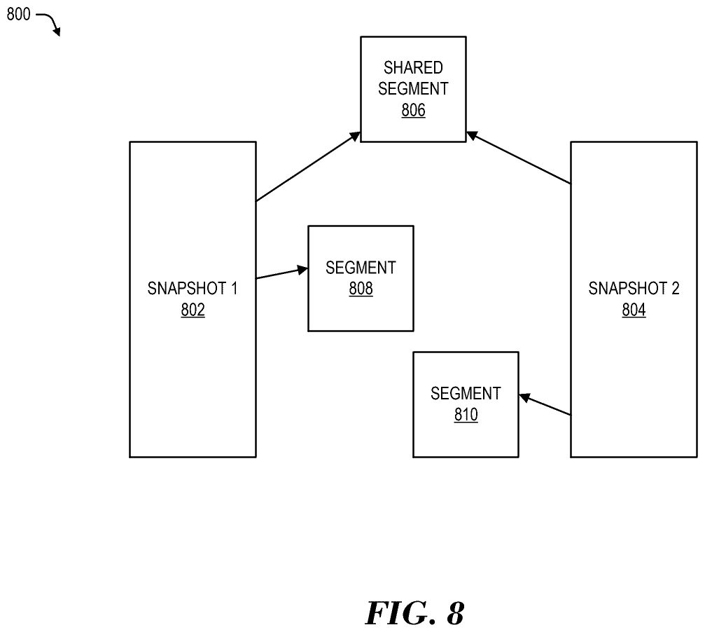

FIG. 8 is an illustration 800 of snapshots and segments according to an example embodiment. The illustration 800 shows a first snapshot 802, a second snapshot 804, and segments 806, 808, and 810. The second snapshot 804 is an incremental snapshot that was taken after the first snapshot 802. The shared segment 806 includes vectors that have not changed since the first snapshot 802. The segment 810 includes vectors that have changed from the vectors in the segment 808 since the first snapshot 802. Both the first snapshot 802 and the second snapshot 804 point to the shared segment 806 that includes vectors that have not changed since the first snapshot 802. The second snapshot 804 points to the segment 810 that includes the vectors that have changed from the vectors in the segment 808 since the first snapshot 802.

A garbage collection mechanism can track and delete older snapshots and segments when they are no longer necessary while maintaining the shared segment 806. For example, there can be multiple snapshots at a given time and the garbage collection policy limits the space usage. The space requirement can also become high if the deleted vectors are not removed from the graph. In case of new inserts, the peak space requirement can be proportional to the total number of indexed vectors. Vectors are not duplicated between two snapshots, unlike the full repopulation technique.

### Index Reload

Another operation that grows the vector memory pool is a vector index reload. The reload involves loading the HNSW index into the vector memory pool after a node has undergone a restart or a startup. The reload uses a disk checkpoint if it is available. Otherwise, it creates a new HNSW index from scratch. When the vector index is reloaded, the vector memory pool typically needs to grow.

As discussed above, if a cluster node is unable to grow the vector memory pool, then a background reload can grow the vector memory pool and create the HNSW index when space is available. In another kind of reload, a cluster node that participated in the HNSW index creation can go down and come back. The database system may choose to remember the vector memory pool size prior to the shutdown. Thus, when the cluster node restarts, a background process can immediately grow the vector memory pool based on a corresponding persisted size parameter value instead of waiting for a vector index reload operation to kick in. For example, a workload may switch from one instance to another instance when a patch needs to be applied to the first instance and the vector memory pool size parameter can be stored and used to grow the vector memory pool on the other instance.

In another kind of reload, a cluster node can start up after creation of an HNSW index on another cluster node. Because this cluster node did not participate in the HNSW build, the vector memory pool grows to allocate space for the HNSW index copy for the cluster node that started after HNSW creation.

### Vector Memory Pool Shrink

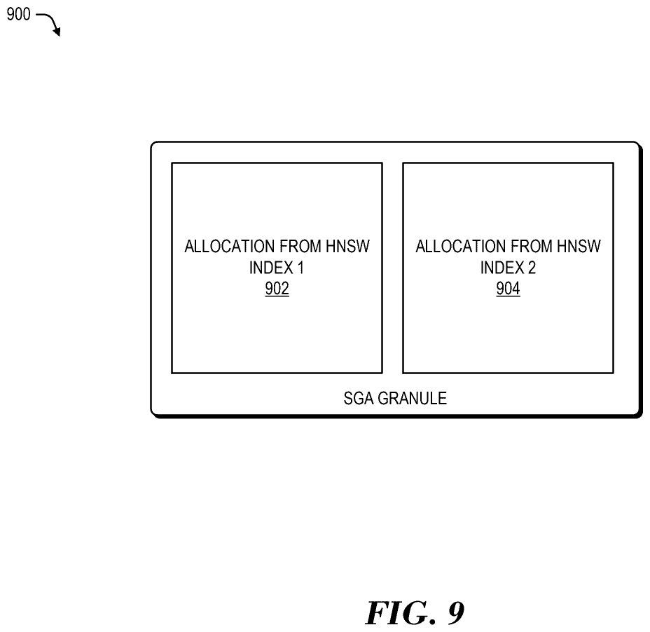

FIG. 9 is an illustration of an SGA granule 900 according to an example embodiment. The SGA granule 900 can include a first allocation 902 of segments from a first HNSW index and a second allocation 904 of segments from a second HNSW index. The vector memory pool memory may shrink when the database resource is scaled down or a database is closed. Allocations from different HNSW indexes may reside on the same shared granule 900 and shrinking of the SGA granule, such as release of the granule for use by other SGA components, can lead to shrinking of multiple HNSW indexes.

The sharing of SGA memory is useful for efficient space management in multi-tenant databases where all tenant databases share the same physical SGA memory, with each having its own quota. Thus, it is useful for each component allocating memory in the SGA (such as HNSW indexes using the vector memory pool) to allow for the elasticity of vector memory pool growth and shrinking.

If the total vector memory pool size after shrinking the SGA granule cannot accommodate an HNSW index, then the HNSW index is evicted from the vector memory pool. The eviction of an HNSW index leads to queries running slower because a query would have to do a full table scan of the base table without using the HNSW index to answer similarity search queries. However, partial vector memory pool shrink operations or relocation operations can be performed. For example, if the vector memory pool size needs to shrink, but the vector memory pool can still accommodate the HNSW index, then the HNSW index is relocated to other available granules.

As discussed above, when database resources are scaled down the vector memory pool usage typically needs to be scaled down proportionately. Different approaches are possible for scaling down the vector memory pool when database resources are scaled down and there is insufficient space for a whole vector index. One approach involves total eviction of an HNSW index. Another approach involves partial eviction of HNSW snapshots.

### Total Eviction of an HNSW Index

One approach for scaling down the vector memory pool when database resources are scaled down is total eviction of HNSW indexes. In an example scenario, there is one HNSW index in the vector memory pool and the vector memory pool needs to shrink to size zero. The HNSW index needs to be evicted and all the allocations for the given HNSW index need to be freed. To perform HNSW index eviction according to a possible example, a granule contains HNSW index segments. The segments have identifiers that track back to the index they belong to. A space layer can identify which granules need to be evicted, can identify the segments corresponding to the granule, can identify which vector indexes correspond to the segments, and can request the release of the granule by dropping the allocations.

For example, vector index metadata can be found using the hash table that maps a vector index identifier to the vector index. The in-memory index metadata is marked as invalid in a node that has a shrinking vector memory pool. Other nodes with no shrink requests can still continue to have their allocated index. The in-memory index metadata can be marked as invalid to prevent new query compilations from generating a plan with vector index access in this cluster node. Existing plan cursors on the base table that have been compiled with an index access plan are invalidated, which ensures that new queries on the node with the shrinking memory pool use a non-indexed plan on the base table. Readers that have started accessing the HNSW index are quiesced by waiting for a reference counter to go down to zero, where the reference counter is used to track the number of threads that are currently accessing the HNSW index. Once the existing readers are gone, no new readers will come in due to the invalidation of the existing cursors, and the vector memory pool can shrink. The vector memory pool footprint for the HNSW index is then dropped by dropping all snapshots that are currently available for the given index.

### Partial Eviction of HNSW Index Snapshots

Another approach for scaling down the vector memory pool when database resources are scaled down is the partial eviction of HNSW index snapshots. In an example scenario, a determination can be made that segments in a granule belong to a particular snapshot. Then the snapshot can be evicted instead of a whole vector index to free up the granule. For example, the vector memory pool has a vector index that has two snapshots where snapshot #1 uses 500 MB and a more recent snapshot #2 uses an additional 100 MB. If the vector memory pool needs to be shrunk by 100 MB, then snapshot #2 can be evicted. Queries operate faster on more recent snapshots because more recent snapshots incorporate more journal entries into the multi-layered index. A journal search is exact, and it can be slower than an approximate graph search. Thus, evicting a more recent snapshot can result in queries accessing the HNSW index running slower because vectors that were indexed in snapshot #2 need to be fetched from the journal table, but this is still faster than querying the base table.

An example process for a partial HNSW index eviction includes finding the index metadata using the hash table that maps an index identifier to the index header. The process includes walking through the HNSW snapshots oldest to newest and computing the size that can be obtained by shrinking a particular HNSW snapshot. This size corresponds to the segments that are currently not being accessed by a newer snapshot.

The process includes repeating a method for each snapshot until the required vector memory pool shrink request is met. The method includes marking the HNSW snapshot as invalid for new queries. Any new query that needs to use this snapshot as the latest snapshot receives a message indicating the snapshot is too old. The method includes quiescing existing readers on the snapshot being evicted by waiting for the snapshot reference counter to go down to zero. The method includes dropping the in-memory footprint corresponding to the snapshot. Any segments that are used by a newer snapshot cannot be dropped.

The above process may not result in enough shrinkable size. In the case of only inserts, snapshot #2 will share most memory with snapshot #1 and the shrinkable size for snapshot #1 would be low. In this case, the newer snapshot #2 can be evicted and queries would need to do an exact search on the extra vectors in snapshot #2 from the journal table. This design may require the contents of the journal table to not be reclaimed for some pre-configured amount of time. There is no need to invalidate existing cursors on the base table because the HNSW index is still available, but some snapshots are missing. Queries that have a valid snapshot available can continue to use an HNSW index access plan.

SGA Granule Shrink when Space is Available to Sustain a Vector Index

For the case of SGA granule shrink when there is available space to sustain a vector index, different approaches are possible. One approach shrinks the HNSW indexes and uses an HNSW reload operation to bring them back. Another approach relocates the HNSW indexes. These approaches can be employed when there is available vector memory pool space for a persisting vector index of one tenant database when another tenant database closes. For example, the persisting vector index may have segments on a granule that is being released because the granule includes segments from another vector index that is closing. In this case, there may be other granules that can be used for the persisting vector index.

Shrinking the HNSW Indexes and Using an HNSW Reload Operation to Bring them Back

One approach for releasing SGA granules when there is available memory for a persisting HNSW index is shrinking the persisting HNSW index, such as by releasing granules with the persisting HNSW index, and using an HNSW reload operation to bring it back, such as by storing the HNSW index to disk and reloading it or by reloading the HNSW index from a checkpoint to available granules. For every SGA granule that has a vector index belonging to the database that is being closed and for every index that belongs to a different tenant database that is active and has a presence in this SGA granule, the HNSW index is evicted as described above, and the HNSW index is reloaded using other granules that do not have a presence from the tenant database that is being closed.

This approach may be easy to implement, but slow because the reload can take a long time. The process operates faster if the HNSW snapshots that have a presence in the SGA granule are uniquely identified and reloaded. The reload operation is faster if a disk checkpoint is available. The reload operation can also be driven by a background process that loads the HNSW indexes back into the vector memory pool in an eventual manner.

### Relocating the HNSW Indexes

Another approach for releasing SGA granules when there is available memory for persisting HNSW indexes is relocating the HNSW indexes and creating a new snapshot. Segments that belong to an SGA granule being shrunk can be efficiently relocated to another SGA granule that is currently available. A new snapshot is effectively the old snapshot because the vectors that are indexed remain the same and no new journal vectors are added, but the new snapshot points to the new granules that include the relocated segments. This maintains the larger vector indexes while giving back space. An HNSW index remains the same between the previous snapshot and the new snapshot with relocated segments.

The process for this approach includes gathering all the segments for a persisting HNSW index that has a presence in an SGA granule being shrunk. A new HNSW snapshot is created and the segments from the granule that needs to be shrunk are relocated to available granules that are not being dropped. For example, a copy on write mechanism relocates the segments to available granules. After the segments are relocated to available granules, the old HNSW snapshot is marked as invalid for access by new queries. Existing readers on the invalid snapshot are quiesced by waiting for the snapshot reference counter to go down to zero. The in-memory footprint is then dropped for the invalid snapshot. The new snapshot carries valid segments over from the invalid snapshot and, thus, those segments are not dropped. Only the invalid segments that belong to granules being shrunk are dropped because they have been relocated to other valid granules. This approach can keep the vector index online for queries as opposed to having the vector index become unavailable when performing a reload operation.

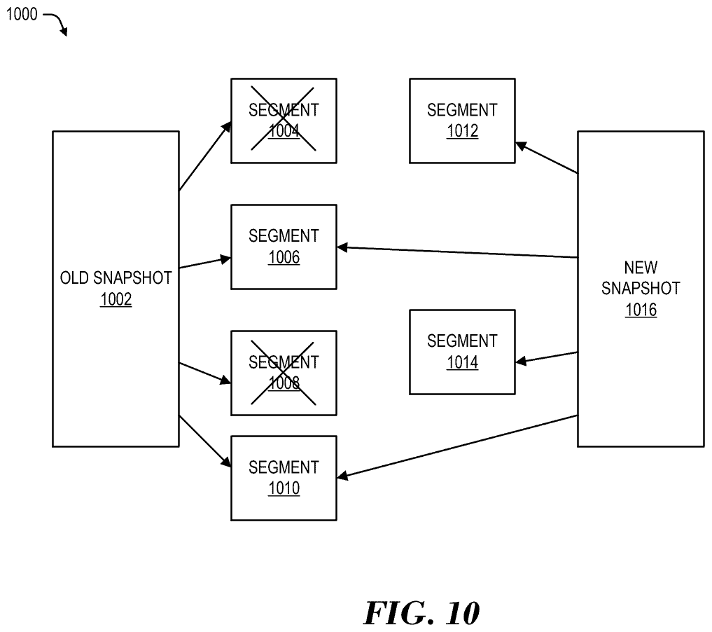

FIG. 10 is an illustration 1000 of relocating segments to available granules using a copy on write mechanism according to an example embodiment. An old snapshot 1002 points to segments on granules 1004, 1006, 1008, and 1010. Granules 1004 and 1008 are being released, such as shrunk. The segments on granules 1004 and 1008 are copied to available granules 1012 and 1014. A new snapshot 1016 is created that points to the segments on the available granules 1012 and 1014 along with the segments on the previous granules 1006 and 1010. Then the old snapshot 1002 can be removed along with the segments on granules 1004 and 1008 to free up space. This results in a partial relocation of an HNSW index. As an alternative, the original snapshot 1002 can be updated to point to the new granules 1012 and 1014, but this may require more maintenance to track reader access of the segments.

### Shrink Policies

The shrink that is triggered due to tenant database resource scaling down can have smart eviction policies. The shrink size request can be honored but the choice of SGA granules to shrink can have different heuristics. For example, the SGA granules that lead to shrinking of the least number of indexes can be chosen. As another example, index-level statistics such as the number of queries that have used the index, the latest time as of which the index was accessed, etc. can be used to determine which indexes should be shrunk to honor the shrink request. Less frequently accessed granules and/or vector indexes can be chosen for shrinking.

### Vector Memory Pool Management for IVF Vector Indexes

A neighbor partitions vector index, such as the IVF index discussed above, includes a centroids table and a centroid partitions table. The centroids table stores the centroid vectors that are generated using a K-means clustering algorithm on a sample of base table vectors. The centroid partitions table stores the best centroid identifier (ID) assignment for every vector that is present in the base table.

The IVF index creation phase involves a clustering phase and a centroid assignment phase. As discussed above, the clustering phase involves running a K-means clustering algorithm on a sampled subset of the base table vectors to determine the centroid vectors for the IVF vector index. The centroid vectors are written into the centroids table at the end of this phase. In the centroid assignment phase, the best centroid ID is determined for every base table vector. For a given base table vector, its best centroid assignment is given by the centroid vector that has the least vector distance. The centroid ID assignment along with the base table vector is written into the centroid partitions table at the end of this phase.

The centroid ID assignment for the base table vectors can be obtained using the following example SQL query involving the centroids, centroid partitions, and the base table:

```
INSERT INTO SYS.VECTOR$IDX$IVF_FLAT_CENTROID_PARTITIONS
  SELECT t2.rowid rid,
    (SELECT t3.centroid_id FROM
SYS.VECTOR$IDX$IVF_FLAT_CENTROIDS t3
      ORDER BY VECTOR_DISTANCE(t2.vec, t3.centroid_vector) ASC FETCH
FIRST 1 ROW ONLY) cid, t2.vec dv
  FROM vectab t2);
```

The inner select subquery that determines the best centroid vector for a given base table vector can be optimized further using a vector pool resident cached copy of the centroid vectors. The cached centroid vectors result in faster performance because it improves the random access of centroid vectors from the buffer cache with contiguous access.

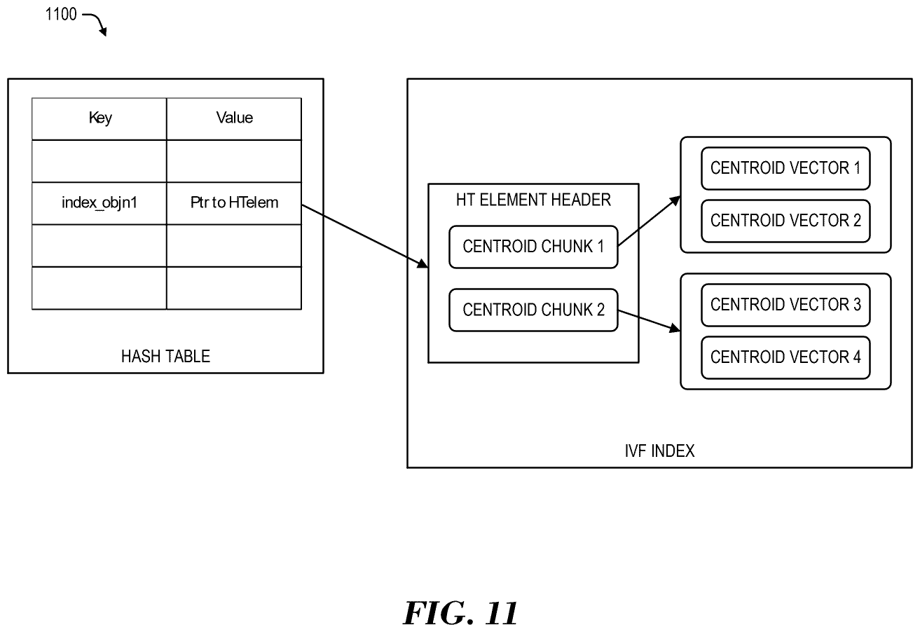

FIG. 11 is an illustration 1100 of a layout of the vector pool resident cached centroids according to an example embodiment. A top-level in-memory hash table tracks the centroid vectors for each IVF vector index. It maps an index object number (index_objn) to the index header that tracks the centroid chunks storing the centroid vectors. This helps in fast access of the vector pool resident centroid vectors for a given IVF index during the centroid assignment phase. The hash table points (Ptr to HTelem) to a hash table element header (HT element header) that is present per IVF index. The HT element header tracks all the vector pool resident centroid vector chunks. Each centroid chunk keeps track of a list of centroid vectors and the centroid identifiers.

The cached centroid vectors can help improve the centroid assignment cost during DML operations that add new base table vectors into the IVF index. An internal SQL query to look up the best centroid using the order by vector distance operator is replaced by a simple lookup of the centroids cache. The centroids cache acts as an accelerator for the centroid assignment. If the cache is not loaded due to the unavailability of memory, then a fallback path involves the execution of a SQL query to fetch the best centroid assignment. The number of centroid vectors is an order of magnitude smaller than the number of base table vectors. Thus, the memory required for keeping the centroid vectors in the cache is significantly less.

The operations described above for an elastic vector index memory pool size for a vector database can be used with IVF indexes in the vector memory pool. For example, the vector pool is grown to keep the centroid vectors cached in memory. Also, a full online rebuild of the IVF index involves a re-clustering algorithm that generates a new set of centroid vectors. The new centroid vectors obtained after the full online rebuild of the IVF index are loaded into the vector pool and the old centroid vectors are dropped. Additionally, a shrink request can be honored by dropping the cached centroid vectors. The fallback path described above is used due to the unavailability of the cached centroid vectors. The vectors can be reloaded into the vector pool by reading the centroids table once enough vector pool space is available.

### Example Methods

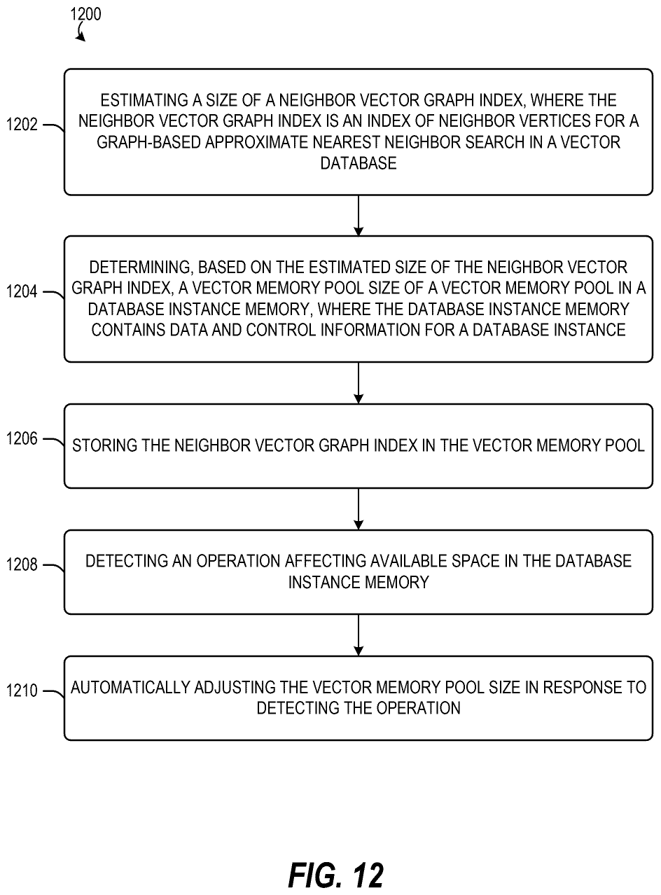

FIG. 12 is a flowchart 1200 of a method for elastic vector index memory pool size for a vector database according to an example embodiment. At 1202, the method includes estimating the size of a neighbor graph vector index, where the neighbor graph vector index is an index of neighbor vertices for a graph-based approximate nearest neighbor search in a vector database. For example, the neighbor graph vector index can be an HNSW index.

At 1204, the method includes determining, based on the estimated size of the neighbor graph vector index, a vector memory pool size of a vector memory pool in a database instance memory, where the database instance memory contains data and control information for a database instance. In an implementation, the database instance memory is the SGA. The SGA is an area of memory that contains data and control information for one database instance. All server and background processes share the SGA. The SGA can be shared among multiple users of the database instance.

The vector memory pool occupies a portion of the database instance memory. Data for other processes of the database instance occupies other portions of the database instance memory. For example, the database instance memory includes a shared pool that is shared by multiple users, includes a flashback buffer for rewinding data back in time to correct problems, includes a database buffer cache that stores copies of data blocks, includes a redo log buffer that holds information about changes to the database, and/or includes information for other processes. The vector memory pool is an area of memory allocated in the database instance memory to vector index information. The vector memory pool stores HNSW vector indexes and all associated metadata. It can also be used for IVF index creation, as well as data manipulation DML operations on base tables with IVF indexes.

At 1206, the method includes storing the neighbor graph vector index in the vector memory pool. At 1208, the method includes detecting an operation affecting available space in the database instance memory. At 1210, the method includes automatically adjusting the vector memory pool size in response to detecting the operation.

In a possible implementation, automatically adjusting includes increasing the vector memory pool size in response to detecting the operation on the neighbor graph vector index. Alternatively, automatically adjusting includes decreasing the vector memory pool size in response to detecting the operation that affects the memory pool size.

In a possible implementation of vector memory pool growth for index creation, the operation includes receiving a request to create a new neighbor graph vector index in the vector memory pool. The method includes estimating the size of the new neighbor graph vector index. The method also includes increasing the vector memory pool size based on the estimated size of the new neighbor graph vector index.

In a possible implementation of vector memory pool growth for index journaling and index refreshing, the operation includes a determination that space is needed based on monitoring space usage by a journal of vector modifications of the neighbor graph vector index. The journal can be a private (or shared) journal that stores data about vector modifications that are initiated by DML statements, such as inserts, deletes, and updates.

In a possible implementation of vector memory pool growth for full index repopulation, the operation includes a full repopulation of the neighbor graph vector index by maintaining the neighbor graph vector index for queries while building a new neighbor graph vector index. In a possible implementation of vector memory pool growth for incremental snapshots, the operation includes creating an incremental snapshot of the neighbor graph vector index based on vector modifications tracked in a journal of vector modifications of the neighbor graph vector index.

In a possible implementation of vector memory pool growth for index reloading, multiple nodes each run an instance of a server of the vector database and the neighbor graph vector index includes a first neighbor graph vector index. The operation includes determining a node has started, and loading a second neighbor graph vector index into the vector memory pool based on determining the node has started.

In a possible operation of vector memory pool shrink, the operation includes dropping a particular neighbor graph vector index. The method includes releasing space in the vector memory pool occupied by the particular neighbor graph vector index. Automatically adjusting includes decreasing the vector memory pool size in response to detecting the dropping of the particular neighbor graph vector index.

In a possible operation of vector memory pool shrink by dropping an index, the operation includes evicting a particular neighbor graph vector index from the vector memory pool. For example, a neighbor graph vector index can be evicted from the memory pool in response to scaling down resources corresponding to the vector memory pool. Automatically adjusting includes decreasing the vector memory pool size in response to evicting the particular neighbor graph vector index from the vector memory pool.

In a possible operation of vector memory pool shrink by partial eviction of snapshots, the operation requires decreasing the vector memory pool size. The vector memory pool includes a plurality of neighbor graph vector index snapshots, each snapshot comprising a different version of the neighbor graph vector index. Automatically adjusting includes determining needed space in the database instance memory to account for decreasing the vector memory pool size, and prioritizing snapshots for removal to provide the needed space. Prioritizing includes prioritizing newer snapshots over older snapshots for removal to provide the needed space. Older snapshots can also be prioritized because newer snapshots include more recent journal entries and provide faster searches. However, dropping the older snapshot may not regain sufficient memory because the newer snapshot may share a majority of the memory as the older snapshot, and dropping the newer one may provide more space.

In a possible operation of vector memory pool shrink when SGA granules are shrinking due to other tenant databases closing, the operation includes closing a tenant database that uses the vector memory pool. Automatically adjusting includes releasing memory used by the closed tenant database in the vector memory pool, and decreasing the vector memory pool size based on the released memory.

In a possible operation of vector memory pool shrink by shrinking and reloading indexes, the operation includes evicting a particular neighbor graph vector index. The database instance memory includes a plurality of granules that each represent a unit of allocation in the database instance memory. At least a portion of the particular neighbor graph vector index occupies a portion of a granule. The method includes determining that a section of a remaining neighbor graph vector index occupies the same granule in the vector memory pool as the particular neighbor graph vector index. The method includes evicting the remaining neighbor graph vector index from the vector memory pool. The method includes reloading the evicted remaining neighbor graph vector index into other granules of the vector memory pool.

In a possible operation of vector memory pool shrink by relocating indexes, the operation includes evicting an evicted neighbor graph vector index. The database instance memory includes a plurality of granules that each represent a unit of allocation in the database instance memory. The method includes determining that a section of the evicted neighbor graph vector index occupies the same granule as a section of a remaining neighbor graph vector index. The method includes relocating the section of the remaining neighbor graph vector index to another granule.

In a possible operation of vector memory pool shrink, the operation includes restarting a server of the vector database. The method includes setting a vector memory pool size limit based on one or more neighbor vector graph indices that existed in the server of the vector database prior to the operation. The method includes reloading the one or more neighbor vector graph indices into the vector memory pool. Reloading includes reloading the existing neighbor vector graph indices from a checkpoint or rebuilding the indices from scratch from the base table.

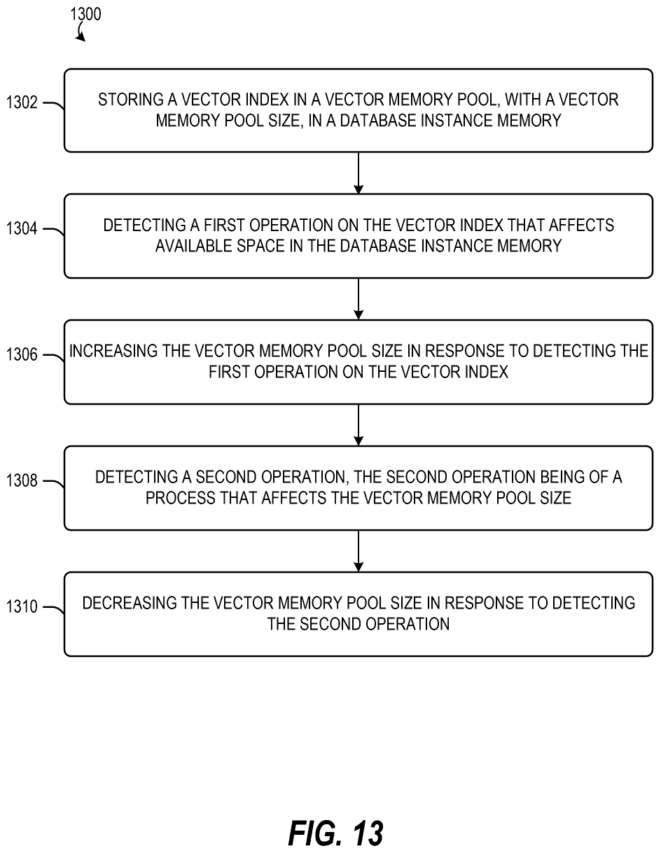

FIG. 13 is a flowchart 1300 of a method for elastic vector index memory pool size for a vector database according to an example embodiment. At 1302, the method includes storing a vector index in a vector memory pool in a database instance memory. The vector index can be an HNSW index, an IVF index, or any other neighbor vector index. The vector memory pool has a vector memory pool size. The database instance memory contains data and control information for a database instance. At 1304, the method includes detecting a first operation on the vector index that affects available space in the database instance memory. At 1306, the method includes increasing the vector memory pool size in response to detecting the first operation on the vector index. At 1308, the method includes detecting a second operation that affects the vector memory pool size. At 1310, the method includes decreasing the vector memory pool size in response to detecting the second operation.

In a possible implementation, the first operation includes creation of the vector index. Increasing the vector memory pool size includes estimating the size of the vector index, and determining, based on the estimated size of the vector index, the vector memory pool size.

In a possible implementation, the first operation comprises rebuilding the vector index and maintaining the vector index for queries while rebuilding the vector index.

In a possible implementation, the second operation includes dropping a particular vector index. The method includes releasing memory in the vector memory pool occupied by the particular vector index. Decreasing the vector memory pool size includes decreasing the vector memory pool size based on the released memory.

In a possible implementation, the second operation includes closing a tenant database that uses the vector memory pool. Decreasing the vector memory pool size includes releasing memory used by the closed tenant database in the vector memory pool, and decreasing the vector memory pool size based on the released memory.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., java file) and the compiled version of the class (i.e., class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

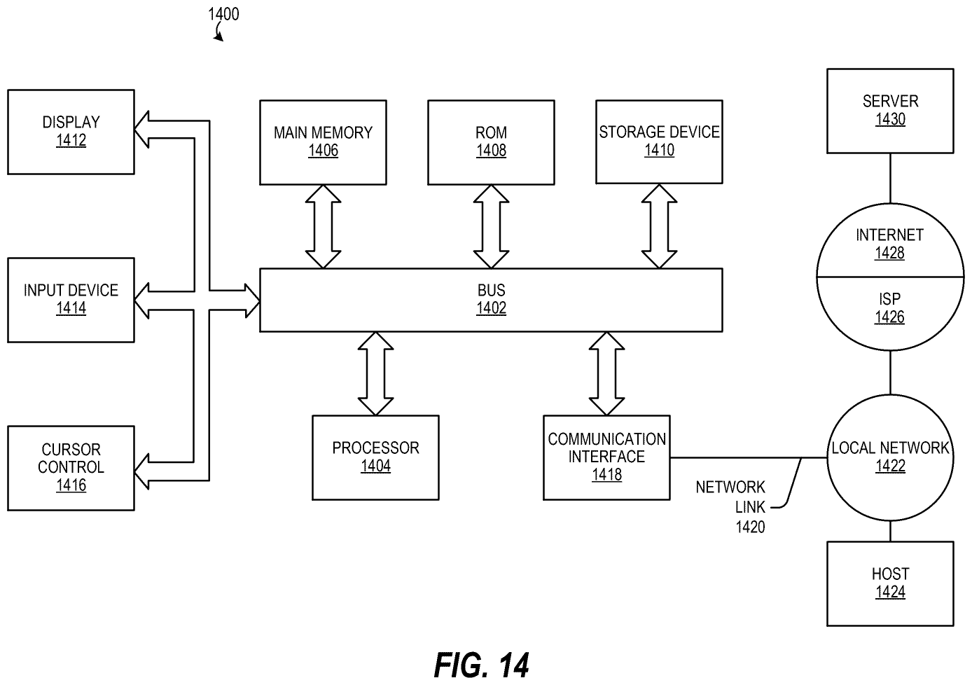

For example, FIG. 14 is a block diagram that illustrates a computer system 1400 upon which aspects of the illustrative embodiments may be implemented. Computer system 1400 includes a bus 1402 or other communication mechanism for communicating information, and a hardware processor 1404 coupled with bus 1402 for processing information. Hardware processor 1404 may be, for example, a general-purpose microprocessor.

Computer system 1400 also includes a main memory 1406, such as a random-access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk, optical disk, or solid-state drive is provided and coupled to bus 1402 for storing information and instructions.

Computer system 1400 may be coupled via bus 1402 to a display 1412 for displaying information to a computer user. An input device 1414, including alphanumeric and other keys, is coupled to bus 1402 for communicating information and command selections to processor 1404. Another type of user input device is cursor control 1416, such as a mouse, a trackball, a touch screen, a track pad, and/or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1410. Volatile media includes dynamic memory, such as main memory 1406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 1400 can receive the data and use, for an example, an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented, such as to a wireless local area network (WLAN) or to a cellular network. In any such implementation, communication interface 1418 sends and receives electrical, electromagnetic, radio, optical, and/or other signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world-wide packet data communication network now commonly referred to as the “Internet” 1428. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### Software Overview

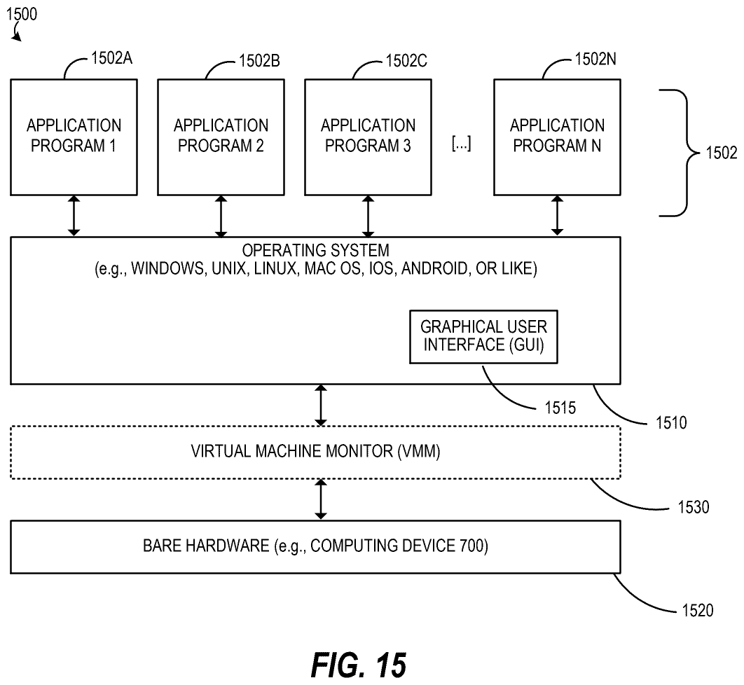

FIG. 15 is a block diagram of a basic software system 1500 that may be employed for controlling the operation of computer system 1400. Software system 1500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1500 is provided for directing the operation of computer system 1400. Software system 1500, which may be stored in system memory (RAM) 1406 and on fixed storage (e.g., hard disk or flash memory) 1410, includes a kernel or operating system (OS) 1510.

The OS 1510 manages low-level aspects of computer operation, including managing execution of processes, memory allocation, file input and output (I/O), and device I/O. One or more application programs, represented as 1502A, 1502B, 1502C . . . 1502N, may be “loaded” (e.g., transferred from fixed storage 1410 into memory 1406) for execution by the system 1500. The applications or other software intended for use on computer system 1400 may also be stored as a set of downloadable computer-executable instructions, for example, for downloading and installation from an Internet location (e.g., a Web server, an app store, or other online service).

Software system 1500 includes a graphical user interface (GUI) 1515, for receiving user commands and data in a graphical (e.g., “point-and-click” or “touch gesture”) fashion. These inputs, in turn, may be acted upon by the system 1500 in accordance with instructions from operating system 1510 and/or application(s) 1502. The GUI 1515 also serves to display the results of operation from the OS 1510 and application(s) 1502, whereupon the user may supply additional inputs or terminate the session (e.g., log off).

OS 1510 can execute directly on the bare hardware 1520 (e.g., processor(s) 1404) of computer system 1400. Alternatively, a hypervisor or virtual machine monitor (VMM) 1530 may be interposed between the bare hardware 1520 and the OS 1510. In this configuration, VMM 1530 acts as a software “cushion” or virtualization layer between the OS 1510 and the bare hardware 1520 of the computer system 1400.

VMM 1530 instantiates and runs one or more virtual machine instances (“guest machines”). Each guest machine comprises a “guest” operating system, such as OS 1510, and one or more applications, such as application(s) 1502, designed to execute on the guest operating system. The VMM 1530 presents the guest operating systems with a virtual operating platform and manages the execution of the guest operating systems.

In some instances, the VMM 1530 may allow a guest operating system to run as if it is running on the bare hardware 1520 of computer system 1400 directly. In these instances, the same version of the guest operating system configured to execute on the bare hardware 1520 directly may also execute on VMM 1530 without modification or reconfiguration. In other words, VMM 1530 may provide full hardware and CPU virtualization to a guest operating system in some instances.

In other instances, a guest operating system may be specially designed or configured to execute on VMM 1530 for efficiency. In these instances, the guest operating system is “aware” that it executes on a virtual machine monitor. In other words, VMM 1530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
estimating a size of a neighbor graph vector index, where the neighbor graph vector index is an index of neighbor vertices for a graph-based approximate nearest neighbor search in a vector database;
determining, based on the estimated size of the neighbor graph vector index, a vector memory pool size of a vector memory pool in a database instance memory, where the database instance memory contains data and control information for a database instance;
storing the neighbor graph vector index in the vector memory pool;
detecting an operation affecting available space in the database instance memory; and
automatically adjusting the vector memory pool size in response to detecting the operation;
wherein the method is performed by one or more computing devices.

2. The method of claim 1, wherein automatically adjusting comprises:
increasing the vector memory pool size in response to detecting the operation on the neighbor graph vector index, or
decreasing the vector memory pool size in response to detecting the operation that affects the memory pool size.

3. The method of claim 1,
wherein the operation comprises receiving a request to create a new neighbor graph vector index in the vector memory pool, and
wherein the method comprises:
estimating a size of the new neighbor graph vector index; and
increasing the vector memory pool size based on the estimated size of the new neighbor graph vector index.

4. The method of claim 1, wherein the operation comprises a determination that space is needed based on monitoring space usage by a journal of vector modifications of the neighbor graph vector index.

5. The method of claim 1, wherein the operation comprises a full repopulation of the neighbor graph vector index by maintaining the neighbor graph vector index for queries while building a new neighbor graph vector index.

6. The method of claim 4, wherein the operation comprises creating an incremental snapshot of the neighbor graph vector index based on vector modifications tracked in a journal of vector modifications of the neighbor graph vector index.

7. The method of claim 1,
wherein multiple nodes each run an instance of a server of the vector database,
wherein the neighbor graph vector index comprises a first neighbor graph vector index, and
wherein the operation comprises:
determining a node has started; and
loading a second neighbor graph vector index into the vector memory pool based on determining the node has started.

8. The method of claim 1,
wherein the operation comprises evicting a particular neighbor graph vector index from the vector memory pool,
wherein automatically adjusting comprises decreasing the vector memory pool size in response to evicting the particular neighbor graph vector index from the vector memory pool.

9. The method of claim 1,
wherein the operation requires decreasing the vector memory pool size,
wherein the vector memory pool comprises a plurality of neighbor graph vector index snapshots, each snapshot comprising a different version of the neighbor graph vector index, and
wherein automatically adjusting comprises:
determining needed space in the database instance memory to account for decreasing the vector memory pool size; and
prioritizing snapshots for removal to provide the needed space.

10. The method of claim 9, wherein prioritizing comprises prioritizing newer snapshots over older snapshots for removal to provide the needed space.

11. The method of claim 1,
wherein the operation comprises closing a tenant database that uses the vector memory pool,
wherein automatically adjusting comprises:
releasing memory used by the closed tenant database in the vector memory pool; and
decreasing the vector memory pool size based on the released memory.

12. The method of claim 1,
wherein the operation comprises evicting a particular neighbor graph vector index,
wherein the database instance memory comprises a plurality of granules that each represent a unit of allocation in the database instance memory,
wherein at least a portion of the particular neighbor graph vector index occupies a portion of a granule,
wherein the method comprises:
determining that a section of a remaining neighbor graph vector index occupies a same granule in the vector memory pool as the particular neighbor graph vector index,
evicting the remaining neighbor graph vector index from the vector memory pool; and
reloading the evicted remaining neighbor graph vector index into other granules of the vector memory pool.

13. The method of claim 1,
wherein the operation comprises evicting an evicted neighbor graph vector index,
wherein the database instance memory comprises a plurality of granules that each represent a unit of allocation in the database instance memory, and
wherein the method comprises:
determining that a section of the evicted neighbor graph vector index occupies a same granule as a section of a remaining neighbor graph vector index; and
relocating the section of the remaining neighbor graph vector index to another granule.

14. The method of claim 1,
wherein the operation comprises restarting a server of the vector database,
wherein the method comprises:
setting a vector memory pool size limit based on one or more neighbor graph vector indices that existed in the server of the vector database prior to the operation; and
reloading the one or more neighbor graph vector indices into the vector memory pool.

15. A method comprising:
storing a vector index in a vector memory pool, with a vector memory pool size, in a database instance memory,
wherein the vector index is an index of vectors in a vector database,
wherein the database instance memory contains data and control information for a database instance;
detecting a first operation, on the vector index, that affects available space in the database instance memory;
increasing the vector memory pool size in response to detecting the first operation on the vector index;
detecting a second operation that affects the vector memory pool size; and
decreasing the vector memory pool size in response to detecting the second operation;
wherein the method is performed by one or more computing devices.

16. The method of claim 15, wherein the vector index comprises
a hierarchical navigable small worlds index, where the hierarchical navigable small worlds index is an index of neighbor vertices for a graph-based approximate nearest neighbor search in the vector database; or
an inverted file vector index, where an inverted file vector index includes partitions of vectors around centroids for approximate nearest neighbor search in the vector database.

17. The method of claim 15,
wherein the first operation comprises creation of the vector index,
wherein increasing the vector memory pool size comprises:
estimating a size of the vector index; and
determining, based on the estimated size of the vector index, the vector memory pool size.

18. The method of claim 15, wherein the first operation comprises rebuilding the vector index and maintaining the vector index for queries while rebuilding the vector index.

19. The method of claim 15,
wherein the second operation comprises dropping a particular vector index,
wherein the method comprises releasing memory in the vector memory pool occupied by the particular vector index,
wherein decreasing the vector memory pool size comprises decreasing the vector memory pool size based on the released memory.

20. The method of claim 15,
wherein the second operation comprises closing a tenant database that uses the vector memory pool,
wherein decreasing the vector memory pool size comprises:
releasing memory used by the closed tenant database in the vector memory pool; and
decreasing the vector memory pool size based on the released memory.

21. One or more non-transitory storage media storing one or more sequences of instructions which, when executed by one or more computing devices, cause:
estimating a size of a neighbor graph vector index, where the neighbor graph vector index is an index of neighbor vertices for a graph-based approximate nearest neighbor search in a vector database;
determining, based on the estimated size of the neighbor graph vector index, a vector memory pool size of a vector memory pool in a database instance memory, where the database instance memory contains data and control information for a database instance;
storing the neighbor graph vector index in the vector memory pool;
detecting an operation affecting available space in the database instance memory; and
automatically adjusting the vector memory pool size in response to detecting the operation;
wherein the method is performed by one or more computing devices.

22. One or more non-transitory storage media storing one or more sequences of instructions which, when executed by one or more computing devices, cause:
storing a vector index in a vector memory pool, with a vector memory pool size, in a database instance memory,
wherein the vector index is an index of vectors in a vector database,
wherein the database instance memory contains data and control information for a database instance;
detecting a first operation, on the vector index, that affects available space in the database instance memory;
increasing the vector memory pool size in response to detecting the first operation on the vector index;
detecting a second operation that affects the vector memory pool size; and
decreasing the vector memory pool size in response to detecting the second operation;
wherein the method is performed by one or more computing devices.
